(19) United States
(12) Patent Application Publication
(10) Pub. No.: US 2022/0095250 A1
(43) Pub. Date: Mar. 24, 2022

(54) METHOD FOR MEASURING LOCATION OF TERMINAL IN WIRELESS COMMUNICATION SYSTEM AND TERMINAL THEREOF

(71) Applicant: LG ELECTRONICS INC., Seoul (KR)

(72) Inventors: Seungmin LEE, Seoul (KR); Hyukjin CHAE, Seoul (KR)

(73) Assignee: LG ELECTRONICS INC., Seoul (KR)

(21) Appl. No.: 17/310,409

(22) PCT Filed: Feb. 3, 2020
(86) PCT No.: PCT/KR2020/001560

§ 371 Date: Jul. 30, 2021

Related U.S. Application Data
(60) Provisional application No. 62/799,804, filed on Feb. 1, 2019.
(60) Provisional application No. 62/799,808, filed on Feb. 1, 2019.
(60) Provisional application No. 62/799,810, filed on Feb. 1, 2019.

(51) Int. Cl. H04W 56/00; H04W 4/029; G01S 5/02; G05D 1/02

(52) U.S. Cl. CPC H04W 56/001; G05D 1/0285; G01S 5/0268; H04W 4/029

(57) ABSTRACT

One embodiment relates to a method for measuring the location of a terminal in a wireless communication system, comprising: a step in which the terminal receives a plurality of first signals from a first fixed node and a second fixed node; a step in which the terminal receives a plurality of second signals from the first fixed node and the second fixed node; a step in which the terminal obtains first reference signal timing difference (RSTD) information on the basis of the plurality of received first signals; a step in which the terminal obtains second RSTD information on the basis of the plurality of received second signals; and a step in which the terminal measures a location of the terminal on the basis of the first RSTD information and the second RSTD information.

### TECHNICAL FIELD

The present disclosure relates to a wireless communication system, and more particularly, to a method of measuring the location of a user equipment (UE) and UE therefor.

### BACKGROUND ART

As more and more communication devices demand larger communication capacities, the need for enhanced mobile broadband communication relative to the legacy radio access technologies (RATs) has emerged. Massive machine type communication (mMTC) that provides various services by interconnecting multiple devices and things irrespective of time and place is also one of main issues to be addressed for future-generation communications. A communication system design considering services/user equipments (UEs) sensitive to reliability and latency is under discussion as well. As such, the introduction of a future-generation RAT considering enhanced mobile broadband (eMBB), mMTC, ultra-reliability and low latency communication (URLLC), and so on is being discussed. For convenience, this technology is referred to as new RAT (NR) in the present disclosure. NR is an exemplary 5th generation (5G) RAT.

A new RAT system including NR adopts orthogonal frequency division multiplexing (OFDM) or a similar transmission scheme. The new RAT system may use OFDM parameters different from long term evolution (LTE) OFDM parameters. Further, the new RAT system may have a larger system bandwidth (e.g., 100 MHz), while following the legacy LTE/LTE-advanced (LTE-A) numerology. Further, one cell may support a plurality of numerologies in the new RAT system. That is, UEs operating with different numerologies may co-exist within one cell.

Vehicle-to-everything (V2X) is a communication technology of exchanging information between a vehicle and another vehicle, a pedestrian, or infrastructure. V2X may cover four types of communications such as vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

### DISCLOSURE

### Technical Problem

The object of the present disclosure is to provide a method of removing a synchronization error between fixed nodes in user equipment (UE) positioning to estimate the location of a UE more effectively.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, a method of measuring a location of a user equipment (UE) in a wireless communication system is provided. The method may include: receiving, by the UE, a plurality of first signals from a first fixed node and a second fixed node; receiving, by the UE, a plurality of second signals from the first fixed node and the second fixed node; obtaining, by the UE, first reference signal time difference (RSTD) information based on the plurality of received first signals; obtaining, by the UE, second RSTD information based on the plurality of received second signals; and measuring, by the UE, the location of the UE based on the first RSTD information and the second RSTD information.

In another aspect of the present disclosure, a UE in a wireless communication system is provided. The UE may include: a transceiver; and a processor. The processor may be configured to: receive a plurality of first signals from a first fixed node and a second fixed node; receive a plurality of second signals from the first fixed node and the second fixed node; obtain first RSTD information based on the plurality of received first signals; obtain second RSTD information based on the plurality of received second signals; and measure a location of the UE based on the first RSTD information and the second RSTD information.

The plurality of first signals may be transmitted from the first fixed node and the second fixed node at a first transmission timing, and the plurality of second signals may be transmitted from the first fixed node and the second fixed node at a second transmission timing different from the first transmission timing.

The method may further include: receiving, by the UE, the plurality of first signals from a third fixed node; receiving, by the UE, the plurality of second signals from the third fixed node; obtaining, by the UE, third RSTD information based on the first signals received from the second fixed node and the third fixed node; obtaining, by the UE, fourth RSTD information based on the second signals received from the second fixed node and the third fixed node; and measuring, by the UE, the location of the UE based on the first RSTD information, the second RSTD information, the third RSTD information, and the fourth RSTD information. The plurality of first signals may be transmitted from the first fixed node, the second fixed node, and the third fixed node at the first transmission timing, and the plurality of second signals may be transmitted from the first fixed node, the second fixed node, and the third fixed node at the second transmission timing different from the first transmission timing.

The method may further include: measuring, by the UE, a distance between a first location of the UE at the first transmission timing and a second location of the UE at the second transmission timing based on sensor information of the UE; and measuring, by the UE, the first location of the UE at the first transmission timing.

Measuring the location of the UE may further include measuring the location of the UE by removing a synchronization error between the first fixed node and the second fixed node based on a difference between the first RSTD information and the second RSTD information.

Measuring the location of the UE may further include measuring the location of the UE by removing a synchronization error between the second fixed node and the third fixed node based on a difference between the third RSTD information and the fourth RSTD information.

The method may include: receiving, by the UE, location information on the first fixed node, location information on the second fixed node, and location information on the third fixed node from the first fixed node, the second fixed node, or the third fixed node; and measuring, by the UE, the location of the UE based on the first RSTD information, the second RSTD information, the third RSTD information, the fourth RSTD information, the location information on the first fixed node, the location information on the second fixed node, and the location information on the third fixed node.

The method may further include: transmitting, by the UE, the first RSTD information, the second RSTD information, the third RSTD information, and the fourth RSTD information to the first fixed node, the second fixed node, or the third fixed node; transmitting, by the UE, information on a distance between a first location of the UE at the first transmission timing and a second location of the UE at the second transmission timing to the first fixed node, the second transmitting the fixed node, or the third fixed node based on sensor information of the UE; and receiving, by the UE, information on the location of the UE from the first fixed node, the second fixed node, or the third fixed node. The received information may be obtained by the first fixed node, the second fixed node, or the third fixed node from information on a difference between the first RSTD information and the second RSTD information, information on a difference between the third RSTD information and the fourth RSTD information, and the information on the distance between the first location of the UE at the first transmission timing and the second location of the UE at the second transmission timing.

The UE may be configured to communicate with at least one of a mobile terminal, a network, or an autonomous driving vehicle other than an apparatus.

The UE may be configured to implement at least one advanced driver assistance system (ADAS) function based on a signal for controlling movement of the UE.

The UE may be configured to switch a driving mode of an apparatus from an autonomous driving mode to a manual driving mode or from the manual driving mode to the autonomous driving mode upon receipt of a user input.

The UE may be configured to perform autonomous driving based on external object information, and the external object information may include at least one of information on presence of an object, information on a location of the object, information on a distance between the UE and the object, or information on a relative speed of the UE with respect to the object.

### Advantageous Effects

According to an embodiment of the present disclosure, a communication system that is not affected by a synchronization error between fixed nodes may be provided.

According to an embodiment of the present disclosure, no effort and operation may be required for synchronization with fixed nodes, thereby reducing the cost and complexity of installing the fixed nodes.

According to an embodiment of the present disclosure, relative location change may be measured based on sensor information of a user equipment (UE), thereby measuring the location more precisely.

According to an embodiment of the present disclosure, the location of a UE may be precisely measured with no effects from a synchronization error between fixed nodes.

It will be appreciated by persons skilled in the art that the effects that could be achieved with the present disclosure are not limited to what has been particularly described hereinabove and other advantages of the present disclosure will be more clearly understood from the following detailed description.

### DESCRIPTION OF DRAWINGS

The accompanying drawings, which are included to provide a further understanding of the present disclosure and are incorporated in and constitute a part of this application, illustrate implementations of the present disclosure and together with the description serve to explain the principle of the disclosure.

FIG. 1 illustrates a frame structure in new radio (NR).

FIG. 2 illustrates a resource grid in NR.

FIG. 3 is a diagram for explaining sidelink synchronization

FIG. 4 illustrates a time resource unit for transmitting a sidelink synchronization signal.

FIG. 5 illustrates a sidelink resource pool.

FIG. 6 illustrates scheduling schemes depending on transmission modes.

FIG. 7 illustrates selection of sidelink transmission resources.

FIG. 8 illustrates transmission of a physical sidelink control channel (PSCCH).

FIG. 9 illustrates PSCCH transmission in sidelink vehicle-to-everything (V2X) communication.

FIG. 10 is a diagram for explaining an observed time difference of arrival (OTDOA) positioning method.

FIG. 11 is a flowchart for explaining an embodiment of the present disclosure.

FIG. 12 is a diagram illustrating a communication system to which an embodiment of the present disclosure is applied.

FIG. 13 is a block diagram illustrating wireless devices to which an embodiment of the present disclosure is applicable.

FIG. 14 is a diagram illustrating a signal processing circuit for transmission signals to which an embodiment of the present disclosure is applicable.

FIG. 15 is a block diagram illustrating wireless devices to which another embodiment of the present disclosure is applicable.

FIG. 16 is a block diagram illustrating a hand-held device to which another embodiment of the present disclosure is applicable.

FIG. 17 is a block diagram illustrating a vehicle or an autonomous driving vehicle to which another embodiment of the present disclosure is applicable.

FIG. 18 illustrates a vehicle to which another embodiment of the present disclosure is applicable.

### BEST MODE

In this document, downlink (DL) communication refers to communication from a base station (BS) to a user equipment (UE), and uplink (UL) communication refers to communication from the UE to the BS. In DL, a transmitter may be a part of the BS and a receiver may be a part of the UE. In UL, a transmitter may be a part of the UE and a receiver may be a part of the BS. Herein, the BS may be referred to as a first communication device, and the UE may be referred to as a second communication device. The term ‘BS’ may be replaced with ‘fixed station’, ‘Node B’, ‘evolved Node B (eNB)’, ‘next-generation node B (gNB)’, ‘base transceiver system (BTS)’, ‘access point (AP)’, ‘network node’, ‘fifth-generation (5G) network node’, ‘artificial intelligence (AI) system’, ‘road side unit (RSU)’, ‘robot’, etc. The term ‘UE’ may be replaced with ‘terminal’, ‘mobile station (MS)’, ‘user terminal (UT)’, ‘mobile subscriber station (MSS)’, ‘subscriber station (SS)’, ‘advanced mobile station (AMS)’, ‘wireless terminal (WT)’, ‘machine type communication (MTC) device’, ‘machine-to-machine (M2M) device’, ‘device-to-device (D2D) device’, ‘vehicle’, ‘robot’, ‘AI module’, etc.

The technology described herein is applicable to various wireless access systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented as radio technology such as universal terrestrial radio access (UTRA) or CDMA2000. The TDMA may be implemented as radio technology such as global system for mobile communications (GSM), general packet radio service (GPRS), or enhanced data rates for GSM evolution (EDGE). The OFDMA may be implemented as radio technology such as the Institute of Electrical and Electronics Engineers (IEEE) 802.11 (Wi-Fi), IEEE 802.16 (WiMAX), IEEE 802-20, evolved UTRA (E-UTRA), etc. The UTRA is a part of a universal mobile telecommunication system (UMTS). 3rd generation partnership project (3GPP) long term evolution (LTE) is a part of evolved UMTS (E-UMTS) using E-UTRA. LTE-advance (LTE-A) or LTE-A pro is an evolved version of 3GPP LTE. 3GPP new radio or new radio access technology (3GPP NR) is an evolved version of 3GPP LTE, LTE-A, or LTE-A pro.

Although the present disclosure is described based on 3GPP communication systems (e.g., LTE-A, NR, etc.) for clarity of description, the spirit of the present disclosure is not limited thereto. LTE refers to technologies beyond 3GPP technical specification (TS) 36.xxx Release 8. In particular, LTE technologies beyond 3GPP TS 36.xxx Release 10 are referred to as LTE-A, and LTE technologies beyond 3GPP TS 36.xxx Release 13 are referred to as LTE-A pro. 3GPP NR refers to technologies beyond 3GPP TS 38.xxx Release 15. LTE/NR may be called ‘3GPP system’. Herein, “xxx” refers to a standard specification number.

In the present disclosure, a node refers to a fixed point capable of transmitting/receiving a radio signal for communication with a UE. Various types of BSs may be used as the node regardless of the names thereof. For example, the node may include a BS, a node B (NB), an eNB, a pico-cell eNB (PeNB), a home eNB (HeNB), a relay, a repeater, etc. A device other than the BS may be the node. For example, a radio remote head (RRH) or a radio remote unit (RRU) may be the node. The RRH or RRU generally has a lower power level than that of the BS. At least one antenna is installed for each node. The antenna may refer to a physical antenna or mean an antenna port, a virtual antenna, or an antenna group. The node may also be referred to as a point.

In the present disclosure, a cell refers to a prescribed geographical area in which one or more nodes provide communication services or a radio resource. When a cell refers to a geographical area, the cell may be understood as the coverage of a node where the node is capable of providing services using carriers. When a cell refers to a radio resource, the cell may be related to a bandwidth (BW), i.e., a frequency range configured for carriers. Since DL coverage, a range within which the node is capable of transmitting a valid signal, and UL coverage, a range within which the node is capable of receiving a valid signal from the UE, depend on carriers carrying the corresponding signals, the coverage of the node may be related to the coverage of the cell, i.e., radio resource used by the node. Accordingly, the term “cell” may be used to indicate the service coverage of a node, a radio resource, or a range to which a signal transmitted on a radio resource may reach with valid strength.

In the present disclosure, communication with a specific cell may mean communication with a BS or node that provides communication services to the specific cell. In addition, a DL/UL signal in the specific cell refers to a DL/UL signal from/to the BS or node that provides communication services to the specific cell. In particular, a cell providing DL/UL communication services to a UE may be called a serving cell. The channel state/quality of the specific cell may refer to the channel state/quality of a communication link formed between the BS or node, which provides communication services to the specific cell, and the UE.

When a cell is related to a radio resource, the cell may be defined as a combination of DL and UL resources, i.e., a combination of DL and UL component carriers (CCs). The cell may be configured to include only DL resources or a combination of DL and UL resources. When carrier aggregation is supported, a linkage between the carrier frequency of a DL resource (or DL CC) and the carrier frequency of a UL resource (or UL CC) may be indicated by system information transmitted on a corresponding cell. The carrier frequency may be equal to or different from the center frequency of each cell or CC. A cell operating on a primary frequency may be referred to as a primary cell (Pcell) or PCC, and a cell operating on a secondary frequency may be referred to as a secondary cell (Scell) or SCC. The Scell may be configured after the UE and BS establish a radio resource control (RRC) connection therebetween by performing an RRC connection establishment procedure, that is, after the UE enters the RRC_CONNECTED state. The RRC connection may mean a path that enables the RRC of the UE and the RRC of the BS to exchange an RRC message. The Scell may be configured to provide additional radio resources to the UE. The Scell and the Pcell may form a set of serving cells for the UE depending on the capabilities of the UE. When the UE is not configured with carrier aggregation or does not support the carrier aggregation although the UE is in the RRC_CONNECTED state, only one serving cell configured with the Pcell exists.

A cell supports a unique radio access technology (RAT). For example, transmission/reception in an LTE cell is performed based on the LTE RAT, and transmission/reception in a 5G cell is performed based on the 5G RAT.

The carrier aggregation is a technology for combining a plurality of carriers each having a system BW smaller than a target BW to support broadband. The carrier aggregation is different from OFDMA in that in the former, DL or UL communication is performed on a plurality of carrier frequencies each forming a system BW (or channel BW) and in the latter, DL or UL communication is performed by dividing a base frequency band into a plurality of orthogonal subcarriers and loading the subcarriers in one carrier frequency. For example, in OFDMA or orthogonal frequency division multiplexing (OFDM), one frequency band with a predetermined system BW is divided into a plurality of subcarriers with a predetermined subcarrier spacing, and information/data is mapped to the plurality of subcarriers. Frequency up-conversion is applied to the frequency band to which the information/data is mapped, and the information/data is transmitted on the carrier frequency in the frequency band. In wireless carrier aggregation, multiple frequency bands, each of which has its own system BW and carrier frequency, may be simultaneously used for communication, and each frequency band used in the carrier aggregation may be divided into a plurality of subcarriers with a predetermined subcarrier spacing.

3GPP communication specifications define DL physical channels corresponding to resource elements carrying information originating from higher (upper) layers of physical layers (e.g., a medium access control (MAC) layer, a radio link control (RLC) layer, a protocol data convergence protocol (PDCP) layer, an RRC layer, a service data adaptation protocol (SDAP) layer, a non-access stratum (NAS) layer, etc.) and DL physical signals corresponding to resource elements which are used by physical layers but do not carry information originating from higher layers. For example, a physical downlink shared channel (PDSCH), a physical broadcast channel (PBCH), a physical multicast channel (PMCH), a physical control format indicator channel (PCFICH), and a physical downlink control channel (PDCCH) are defined as the DL physical channels, and a reference signal and a synchronization signal are defined as the DL physical signals. A reference signal (RS), which is called a pilot signal, refers to a predefined signal with a specific waveform known to both the BS and UE. For example, a cell-specific RS (CRS), a UE-specific RS (UE-RS), a positioning RS (PRS), a channel state information RS (CSI-RS), and a demodulation reference signal (DMRS) may be defined as DL RSs. In addition, the 3GPP communication specifications define UL physical channels corresponding to resource elements carrying information originating from higher layers and UL physical signals corresponding to resource elements which are used by physical layers but do not carry information originating from higher layers. For example, a physical uplink shared channel (PUSCH), a physical uplink control channel (PUCCH), and a physical random access channel (PRACH) are defined as the UL physical channels, and a demodulation reference signal (DMRS) for a UL control/data signal and a sounding reference signal (SRS) used for UL channel measurement are defined as the UL physical signals.

In the present disclosure, the PDCCH and the PDSCH may refer to a set of time-frequency resources or resource elements carrying downlink control information (DCI) of the physical layer and a set of time-frequency resources or resource elements carrying DL data thereof, respectively. The PUCCH, the PUSCH, and the PRACH may refer to a set of time-frequency resources or resource elements carrying uplink control information (UCI) of the physical layer, a set of time-frequency resources or resource elements carrying UL data thereof, and a set of time-frequency resources or resource elements carrying random access signals thereof, respectively. When it is said that a UE transmits a UL physical channel (e.g., PUCCH, PUSCH, PRACH, etc.), it may mean that the UE transmits UCI, UL data, or a random access signal on or over the corresponding UL physical channel. When it is said that the BS receives a UL physical channel, it may mean that the BS receives UCI, UL data, a random access signal on or over the corresponding UL physical channel. When it is said that the BS transmits a DL physical channel (e.g., PDCCH, PDSCH, etc.), it may mean that the BS transmits DCI or UL data on or over the corresponding DL physical channel. When it is said that the UE receives a DL physical channel, it may mean that the UE receives DCI or UL data on or over the corresponding DL physical channel.

In the present disclosure, a transport block may mean the payload for the physical layer. For example, data provided from the higher layer or MAC layer to the physical layer may be referred to as the transport block.

In the present disclosure, hybrid automatic repeat request (HARQ) may mean a method used for error control. A HARQ acknowledgement (HARQ-ACK) transmitted in DL is used to control an error for UL data, and a HARQ-ACK transmitted in UL is used to control an error for DL data. A transmitter that performs the HARQ operation waits for an ACK signal after transmitting data (e.g. transport blocks or codewords). A receiver that performs the HARQ operation transmits an ACK signal only when the receiver correctly receives data. If there is an error in the received data, the receiver transmits a negative ACK (NACK) signal. Upon receiving the ACK signal, the transmitter may transmit (new) data but, upon receiving the NACK signal, the transmitter may retransmit the data. Meanwhile, there may be a time delay until the BS receives ACK/NACK from the UE and retransmits data after transmitting scheduling information and data according to the scheduling information. The time delay occurs due to a channel propagation delay or a time required for data decoding/encoding. Accordingly, if new data is transmitted after completion of the current HARQ process, there may be a gap in data transmission due to the time delay. To avoid such a gap in data transmission during the time delay, a plurality of independent HARQ processes are used. For example, when there are 7 transmission occasions between initial transmission and retransmission, a communication device may perform data transmission with no gap by managing 7 independent HARQ processes. When the communication device uses a plurality of parallel HARQ processes, the communication device may successively perform UL/DL transmission while waiting for HARQ feedback for previous UL/DL transmission.

In the present disclosure, CSI collectively refers to information indicating the quality of a radio channel (also called a link) created between a UE and an antenna port. The CSI includes at least one of a channel quality indicator (CQI), a precoding matrix indicator (PMI), a CSI-RS resource indicator (CRI), an SSB resource indicator (SSBRI), a layer indicator (LI), a rank indicator (RI), or a reference signal received power (RSRP).

In the present disclosure, frequency division multiplexing (FDM) may mean that signals/channels/users are transmitted/received on different frequency resources, and time division multiplexing (TDM) may mean that signals/channels/users are transmitted/received on different time resources.

In the present disclosure, frequency division duplex (FDD) refers to a communication scheme in which UL communication is performed on a UL carrier and DL communication is performed on a DL carrier linked to the UL carrier, and time division duplex (TDD) refers to a communication scheme in which UL and DL communication are performed by splitting time.

The details of the background, terminology, abbreviations, etc. used herein may be found in documents published before the present disclosure. For example, 3GPP TS 24 series, 3GPP TS 34 series, and 3GPP TS 38 series may be referenced (http://www.3gpp.org/specifications/specification-numbering).

Frame Structure

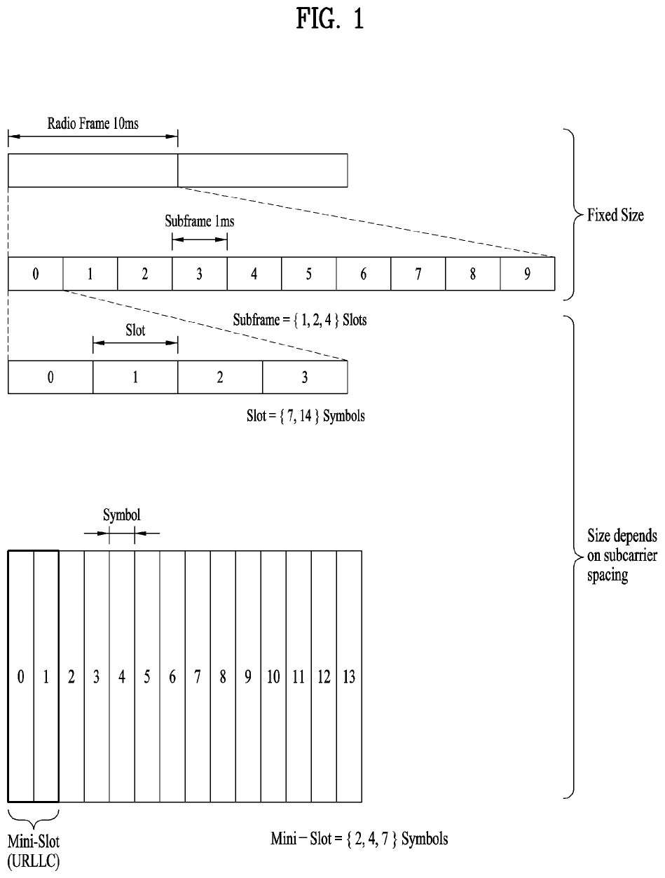

FIG. 1 is a diagram illustrating a frame structure in NR.

The NR system may support multiple numerologies. The numerology is defined by a subcarrier spacing and cyclic prefix (CP) overhead. A plurality of subcarrier spacings may be derived by scaling a basic subcarrier spacing by an integer N (or μ). The numerology may be selected independently of the frequency band of a cell although it is assumed that a small subcarrier spacing is not used at a high carrier frequency. In addition, the NR system may support various frame structures based on the multiple numerologies.

Hereinafter, an OFDM numerology and a frame structure, which may be considered in the NR system, will be described. Table 1 shows multiple OFDM numerologies supported in the NR system. The value of for a bandwidth part and a CP may be obtained by RRC parameters provided by the BS.

TABLE 1

| μ | Δf = 2^{μ}*15 [kHz] | Cyclic prefix(CP) |
|---|---|---|
| 0 | 15 | Normal |
| 1 | 30 | Normal |
| 2 | 60 | Normal, Extended |
| 3 | 120 | Normal |
| 4 | 240 | Normal |

The NR system supports multiple numerologies (e.g., subcarrier spacings) to support various 5G services. For example, the NR system supports a wide area in conventional cellular bands in a subcarrier spacing of 15 kHz and supports a dense urban environment, low latency, and wide carrier BW in a subcarrier spacing of 30/60 kHz. In a subcarrier spacing of 60 kHz or above, the NR system supports a BW higher than 24.25 GHz to overcome phase noise.

Resource Grid

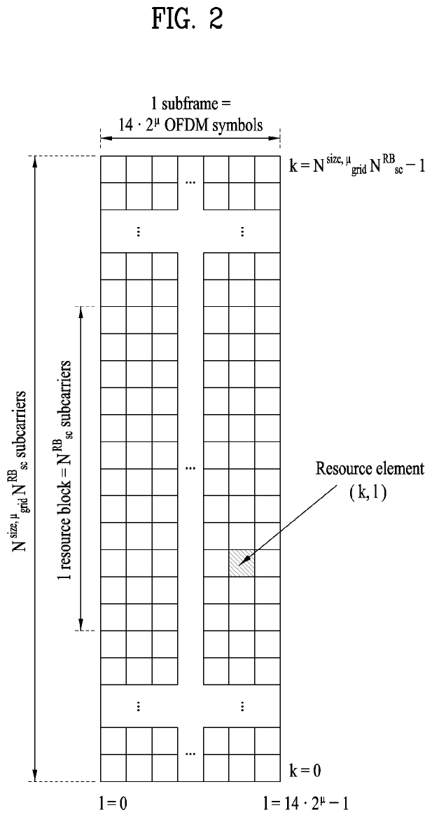

FIG. 2 illustrates a resource grid in the NR.

Referring to FIG. 2, a resource grid consisting of Nsize,μgrid*NRBsc subcarriers and 14*2μ OFDM symbols may be defined for each subcarrier spacing configuration and carrier, where Nsize, grid is indicated by RRC signaling from the BS. Nsize, grid may vary not only depending on the subcarrier spacing configuration μ but also between UL and DL. One resource grid exists for the subcarrier spacing configuration μ, an antenna port p, and a transmission direction (i.e., UL or DL). Each element in the resource gird for the subcarrier spacing configuration and the antenna port p may be referred to as a resource element and identified uniquely by an index pair of (k, l), where k denotes an index in the frequency domain and l denotes the relative location of a symbol in the frequency domain with respect to a reference point. The resource element (k, l) for the subcarrier spacing configuration and the antenna port p may be a physical resource and a complex value, a(p,μ)k,l. A resource block (RB) is defined as NRBsc consecutive subcarriers in the frequency domain (where NRBsc=12).

Considering the point that the UE is incapable of supporting a wide BW supported in the NR system, the UE may be configured to operate in a part of the frequency BW of a cell (hereinafter referred to as a bandwidth part (BWP)).

Bandwidth Part (BWP)

The NR system may support up to 400 MHz for each carrier. If the UE always keeps a radio frequency (RF) module on for all carriers while operating on such a wideband carrier, the battery consumption of the UE may increase. Considering multiple use cases (e.g., eMBB, URLLC, mMTC, V2X, etc.) operating in one wideband carrier, a different numerology (e.g., subcarrier spacing) may be supported for each frequency band of the carrier. Further, considering that each UE may have a different capability regarding the maximum BW, the BS may instruct the UE to operate only in a partial BW rather than the whole BW of the wideband carrier. The partial bandwidth is referred to as the BWP. The BWP is a subset of contiguous common RBs defined for numerology μi in BWP i of the carrier in the frequency domain, and one numerology (e.g., subcarrier spacing, CP length, and/or slot/mini-slot duration) may be configured for the BWP.

The BS may configure one or more BWPs in one carrier configured for the UE. Alternatively, if UEs are concentrated in a specific BWP, the BS may move some UEs to another BWP for load balancing. For frequency-domain inter-cell interference cancellation between neighbor cells, the BS may configure BWPs on both sides of a cell except for some central spectra in the whole BW in the same slot. That is, the BS may configure at least one DL/UL BWP for the UE associated with the wideband carrier, activate at least one of DL/UL BWP(s) configured at a specific time (by L1 signaling which is a physical-layer control signal, a MAC control element (CE) which is a MAC-layer control signal, or RRC signaling), instruct the UE to switch to another configured DL/UL BWP (by L1 signaling, a MAC CE, or RRC signaling), or set a timer value and switch the UE to a predetermined DL/UL BWP upon expiration of the timer value. In particular, an activated DL/UL BWP is referred to as an active DL/UL BWP. While performing initial access or before setting up an RRC connection, the UE may not receive a DL/UL BWP configuration. A DL/UL BWP that the UE assumes in this situation is referred to as an initial active DL/UL BWP.

Synchronization Acquisition of Sidelink UE

In time division multiple access (TDMA) and frequency division multiple access (FDMA) systems, accurate time and frequency synchronization is essential. If time and frequency synchronization is not accurate, inter-symbol interference (ISI) and inter-carrier interference (ICI) may occur so that system performance may be degraded. This may occur in V2X. For time/frequency synchronization in V2X, a sidelink synchronization signal (SLSS) may be used in the physical layer, and master information block-sidelink-V2X (MIB-SL-V2X) may be used in the RLC layer.

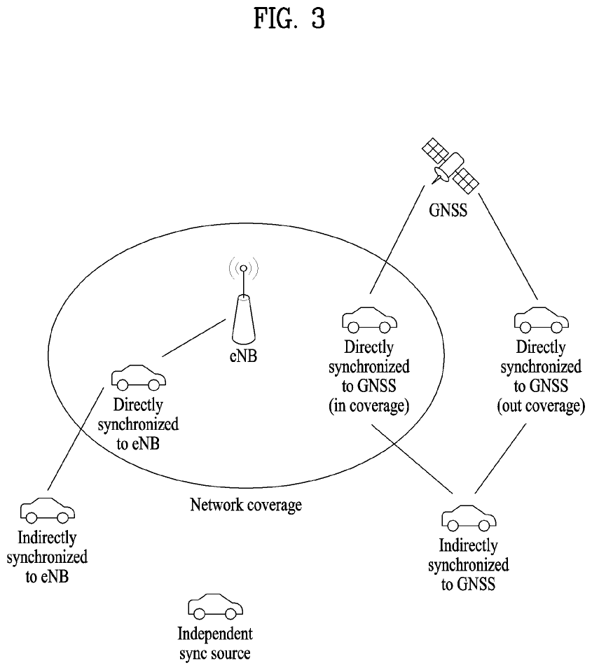

FIG. 3 illustrates a synchronization source and a synchronization reference in V2X.

Referring to FIG. 3, in V2X, a UE may be directly synchronized to global navigation satellite systems (GNSS) or indirectly synchronized to the GNSS through another UE (in or out of the network coverage) that is directly synchronized to the GNSS. When the GNSS is set to the synchronization source, the UE may calculate a direct frame number (DFN) and a subframe number based on coordinated universal time (UTC) and a (pre)configured DFN offset.

Alternatively, the UE may be directly synchronized to the BS or synchronized to another UE that is time/frequency synchronized to the BS. For example, if the UE is in the coverage of the network, the UE may receive synchronization information provided by the BS and be directly synchronized to the BS. Thereafter, the UE may provide the synchronization information to another adjacent UE. If the timing of the BS is set to the synchronization reference, the UE may follow a cell associated with a corresponding frequency (if the UE is in the cell coverage at the corresponding frequency) or follow a Pcell or serving cell (if the UE is out of the cell coverage at the corresponding frequency) for synchronization and DL measurement.

The serving cell (BS) may provide a synchronization configuration for carriers used in V2X sidelink communication. In this case, the UE may follow the synchronization configuration received from the BS. If the UE detects no cell from the carriers used in the V2X sidelink communication and receives no synchronization configuration from the serving cell, the UE may follow a predetermined synchronization configuration.

Alternatively, the UE may be synchronized to another UE that fails to directly or indirectly obtain the synchronization information from the BS or GNSS. The synchronization source and preference may be preconfigured for the UE or configured in a control message from the BS.

Hereinbelow, the SLSS and synchronization information will be described.

The SLSS may be a sidelink-specific sequence and include a primary sidelink synchronization signal (PSSS) and a secondary sidelink synchronization signal (SSSS).

Each SLSS may have a physical layer sidelink synchronization identity (ID), and the value may be, for example, any of 0 to 335. The synchronization source may be identified depending on which of the above values is used. For example, 0, 168, and 169 may indicate the GNSS, 1 to 167 may indicate the BS, and 170 to 335 may indicate out-of-coverage. Alternatively, among the values of the physical layer sidelink synchronization ID, 0 to 167 may be used by the network, and 168 to 335 may be used for the out-of-coverage state.

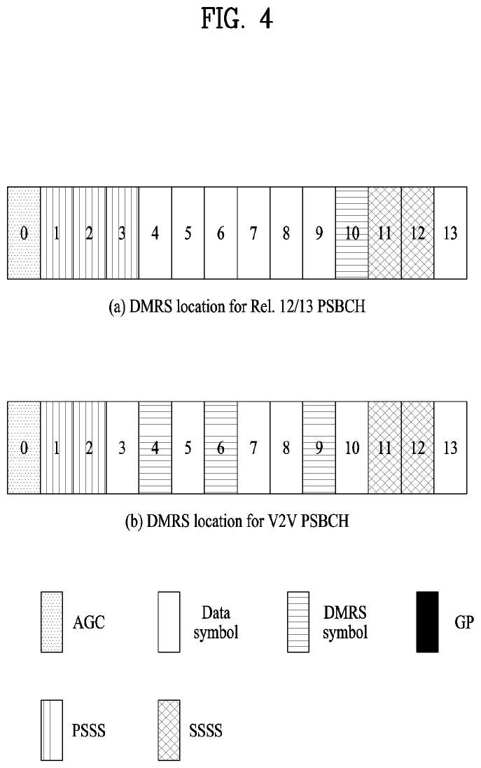

FIG. 4 illustrates a time resource unit for SLSS transmission. The time resource unit may be a subframe in LTE/LTE-A and a slot in 5G. The details may be found in 3GPP TS 36 series or 3GPP TS 28 series. A physical sidelink broadcast channel (PSBCH) may refer to a channel for carrying (broadcasting) basic (system) information that the UE needs to know before sidelink signal transmission and reception (e.g., SLSS-related information, a duplex mode (DM), a TDD UL/DL configuration, information about a resource pool, the type of an SLSS-related application, a subframe offset, broadcast information, etc.). The PSBCH and SLSS may be transmitted in the same time resource unit, or the PSBCH may be transmitted in a time resource unit after that in which the SLSS is transmitted. A DMRS may be used to demodulate the PSBCH.

Sidelink Transmission Mode

For sidelink communication, transmission modes 1, 2, 3 and 4 are used.

In transmission mode 1/3, the BS performs resource scheduling for UE 1 over a PDCCH (more specifically, DCI) and UE 1 performs D2D/V2X communication with UE 2 according to the corresponding resource scheduling. After transmitting sidelink control information (SCI) to UE 2 over a physical sidelink control channel (PSCCH), UE 1 may transmit data based on the SCI over a physical sidelink shared channel (PSSCH). Transmission modes 1 and 3 may be applied to D2D and V2X, respectively.

Transmission mode 2/4 may be a mode in which the UE performs autonomous scheduling (self-scheduling). Specifically, transmission mode 2 is applied to D2D. The UE may perform D2D operation by autonomously selecting a resource from a configured resource pool. Transmission mode 4 is applied to V2X. The UE may perform V2X operation by autonomously selecting a resource from a selection window through a sensing process. After transmitting the SCI to UE 2 over the PSCCH, UE 1 may transmit data based on the SCI over the PSSCH. Hereinafter, the term ‘transmission mode’ may be simply referred to as ‘mode’.

Control information transmitted by a BS to a UE over a PDCCH may be referred to as DCI, whereas control information transmitted by a UE to another UE over a PSCCH may be referred to as SCI. The SCI may carry sidelink scheduling information. The SCI may have several formats, for example, SCI format 0 and SCI format 1.

SCI format 0 may be used for scheduling the PSSCH. SCI format 0 may include a frequency hopping flag (1 bit), a resource block allocation and hopping resource allocation field (the number of bits may vary depending on the number of sidelink RBs), a time resource pattern (7 bits), a modulation and coding scheme (MCS) (5 bits), a time advance indication (11 bits), a group destination ID (8 bits), etc.

SCI format 1 may be used for scheduling the PSSCH. SCI format 1 may include a priority (3 bits), a resource reservation (4 bits), the location of frequency resources for initial transmission and retransmission (the number of bits may vary depending on the number of sidelink subchannels), a time gap between initial transmission and retransmission (4 bits), an MCS (5 bits), a retransmission index (1 bit), a reserved information bit, etc. Hereinbelow, the term ‘reserved information bit’ may be simply referred to as ‘reserved bit’. The reserved bit may be added until the bit size of SCI format 1 becomes 32 bits.

SCI format 0 may be used for transmission modes 1 and 2, and SCI format 1 may be used for transmission modes 3 and 4.

Sidelink Resource Pool

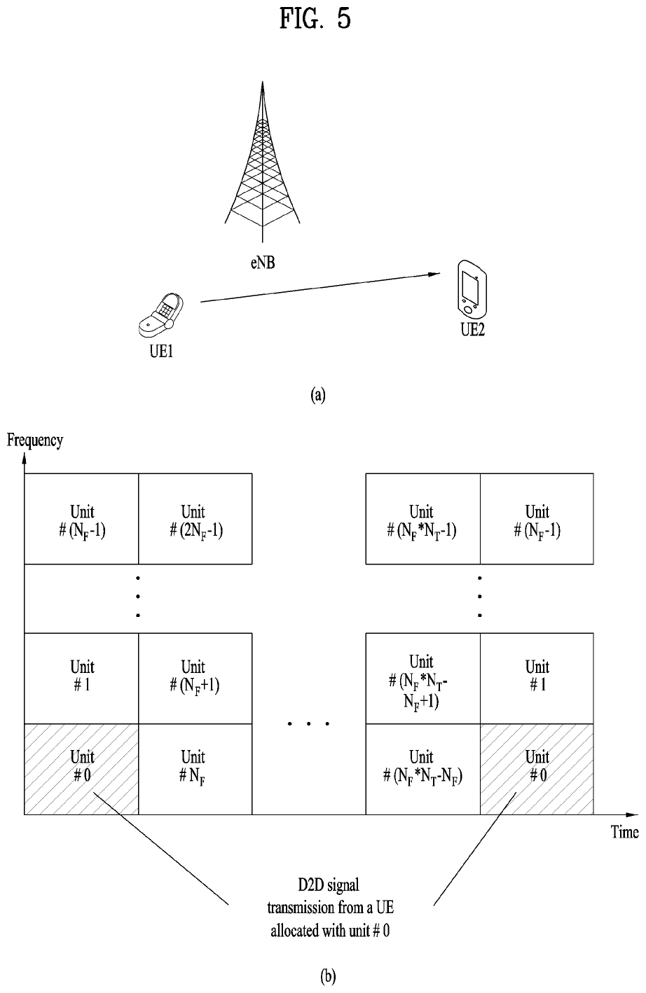

FIG. 5 shows an example of a first UE (UE1), a second UE (UE2) and a resource pool used by UE1 and UE2 performing sidelink communication.

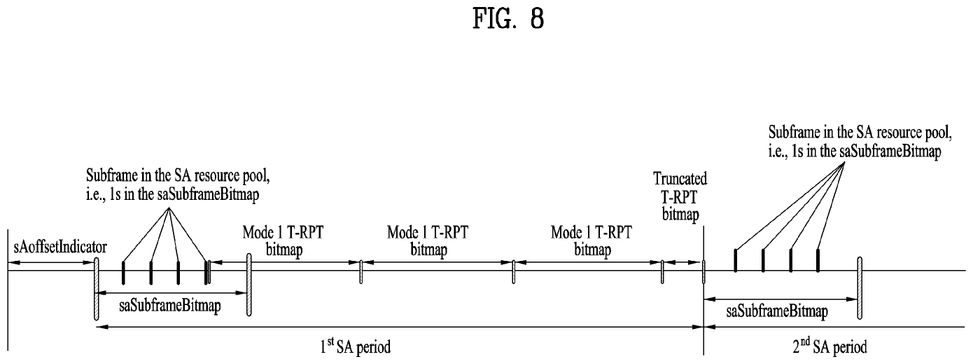

In FIG. 5(a), a UE corresponds to a terminal or such a network device as a BS transmitting and receiving a signal according to a sidelink communication scheme. A UE selects a resource unit corresponding to a specific resource from a resource pool corresponding to a set of resources and the UE transmits a sidelink signal using the selected resource unit. UE2 corresponding to a receiving UE receives a configuration of a resource pool in which UE1 is able to transmit a signal and detects a signal of UE1 in the resource pool. In this case, if UE1 is located in the coverage of a BS, the BS may inform UE1 of the resource pool. If UE1 is located out of the coverage of the BS, the resource pool may be informed by a different UE or may be determined by a predetermined resource. In general, a resource pool includes a plurality of resource units. A UE selects one or more resource units from among a plurality of the resource units and may be able to use the selected resource unit(s) for sidelink signal transmission. FIG. 5(b) shows an example of configuring a resource unit. Referring to FIG. 8(b), the entire frequency resources are divided into the NF number of resource units and the entire time resources are divided into the NT number of resource units. In particular, it is able to define NF*NT number of resource units in total. In particular, a resource pool may be repeated with a period of NT subframes. Specifically, as shown in FIG. 8, one resource unit may periodically and repeatedly appear. Or, an index of a physical resource unit to which a logical resource unit is mapped may change with a predetermined pattern according to time to obtain a diversity gain in time domain and/or frequency domain. In this resource unit structure, a resource pool may correspond to a set of resource units capable of being used by a UE intending to transmit a sidelink signal.

A resource pool may be classified into various types. First of all, the resource pool may be classified according to contents of a sidelink signal transmitted via each resource pool. For example, the contents of the sidelink signal may be classified into various signals and a separate resource pool may be configured according to each of the contents. The contents of the sidelink signal may include a scheduling assignment (SA or physical sidelink control channel (PSCCH)), a sidelink data channel, and a discovery channel. The SA may correspond to a signal including information on a resource position of a sidelink data channel, information on a modulation and coding scheme (MCS) necessary for modulating and demodulating a data channel, information on a MIMO transmission scheme, information on a timing advance (TA), and the like. The SA signal may be transmitted on an identical resource unit in a manner of being multiplexed with sidelink data. In this case, an SA resource pool may correspond to a pool of resources that an SA and sidelink data are transmitted in a manner of being multiplexed. The SA signal may also be referred to as a sidelink control channel or a physical sidelink control channel (PSCCH). The sidelink data channel (or, physical sidelink shared channel (PSSCH)) corresponds to a resource pool used by a transmitting UE to transmit user data. If an SA and a sidelink data are transmitted in a manner of being multiplexed in an identical resource unit, sidelink data channel except SA information may be transmitted only in a resource pool for the sidelink data channel. In other word, REs, which are used to transmit SA information in a specific resource unit of an SA resource pool, may also be used for transmitting sidelink data in a sidelink data channel resource pool. The discovery channel may correspond to a resource pool for a message that enables a neighboring UE to discover transmitting UE transmitting information such as ID of the UE, and the like.

Despite the same contents, sidelink signals may use different resource pools according to the transmission and reception properties of the sidelink signals. For example, despite the same sidelink data channels or the same discovery messages, they may be distinguished by different resource pools according to transmission timing determination schemes for the sidelink signals (e.g., whether a sidelink signal is transmitted at the reception time of a synchronization reference signal or at a time resulting from applying a predetermined TA to the reception time of the synchronization reference signal), resource allocation schemes for the sidelink signals (e.g., whether a BS configures the transmission resources of an individual signal for an individual transmitting UE or the individual transmitting UE autonomously selects the transmission resources of an individual signal in a pool), the signal formats of the sidelink signals (e.g., the number of symbols occupied by each sidelink signal in one subframe or the number of subframes used for transmission of a sidelink signal), signal strengths from the BS, the transmission power of a sidelink UE, and so on. In sidelink communication, a mode in which a BS directly indicates transmission resources to a sidelink transmitting UE is referred to as sidelink transmission mode 1, and a mode in which a transmission resource area is preconfigured or the BS configures a transmission resource area and the UE directly selects transmission resources is referred to as sidelink transmission mode 2. In sidelink discovery, a mode in which a BS directly indicates resources is referred to as Type 2, and a mode in which a UE selects transmission resources directly from a preconfigured resource area or a resource area indicated by the BS is referred to as Type 1.

In V2X, sidelink transmission mode 3 based on centralized scheduling and sidelink transmission mode 4 based on distributed scheduling are available.

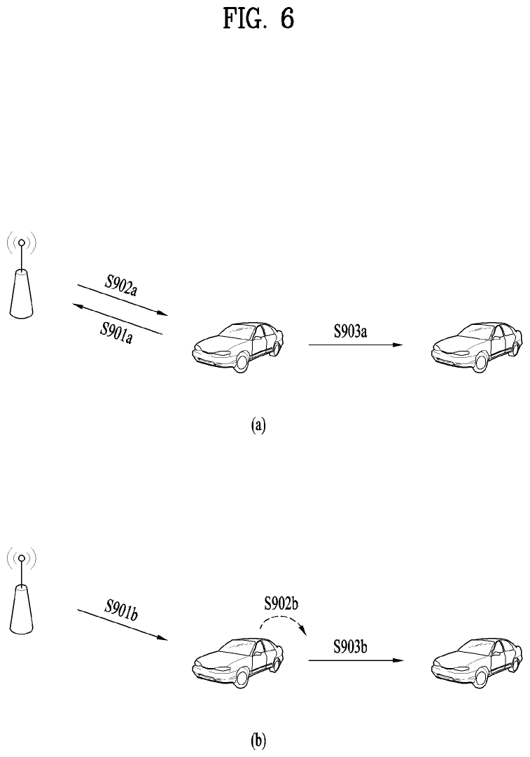

FIG. 6 illustrates scheduling schemes based on these two transmission modes. Referring to FIG. 6, in transmission mode 3 based on centralized scheduling of FIG. 6(a), a vehicle requests sidelink resources to a BS (S901a), and the BS allocates the resources (S902a). Then, the vehicle transmits a signal on the resources to another vehicle (S903a). In the centralized transmission, resources on another carrier may also be scheduled. In transmission mode 4 based on distributed scheduling of FIG. 6(b), a vehicle selects transmission resources (S902b) by sensing a resource pool, which is preconfigured by a BS (S901b). Then, the vehicle may transmit a signal on the selected resources to another vehicle (S903b).

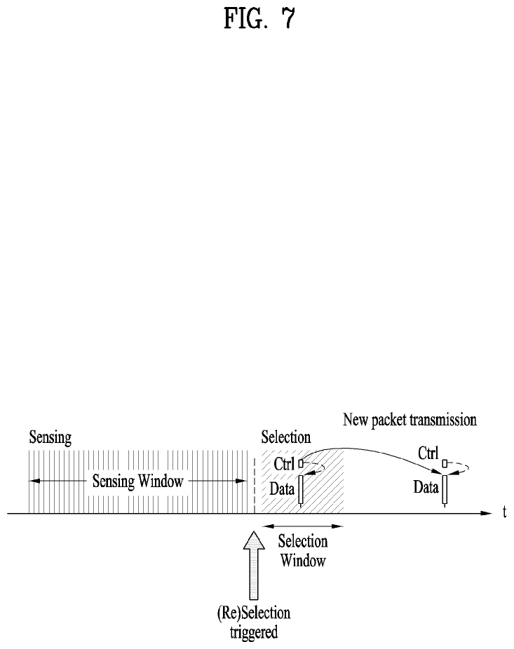

When the transmission resources are selected, transmission resources for a next packet are also reserved as illustrated in FIG. 7. In V2X, transmission is performed twice for each MAC PDU. When resources for initial transmission are selected, resources for retransmission are also reserved with a predetermined time gap from the resources for the initial transmission. The UE may identify transmission resources reserved or used by other UEs through sensing in a sensing window, exclude the transmission resources from a selection window, and randomly select resources with less interference from among the remaining resources.

For example, the UE may decode a PSCCH including information about the cycle of reserved resources within the sensing window and measure PSSCH RSRP on periodic resources determined based on the PSCCH. The UE may exclude resources with PSCCH RSRP more than a threshold from the selection window. Thereafter, the UE may randomly select sidelink resources from the remaining resources in the selection window.

Alternatively, the UE may measure received signal strength indication (RSSI) for the periodic resources in the sensing window and identify resources with less interference, for example, the bottom 20 percent. After selecting resources included in the selection window from among the periodic resources, the UE may randomly select sidelink resources from among the resources included in the selection window. For example, when PSCCH decoding fails, the above method may be applied.

The details thereof may be found in clause 14 of 3GPP TS 3GPP TS 36.213 V14.6.0, which are incorporated herein by reference.

Transmission and Reception of PSCCH

In sidelink transmission mode 1, a UE may transmit a PSCCH (sidelink control signal, SCI, etc.) on a resource configured by a BS. In sidelink transmission mode 2, the BS may configure resources used for sidelink transmission for the UE, and the UE may transmit the PSCCH by selecting a time-frequency resource from among the configured resources.

FIG. 8 shows a PSCCH period defined for sidelink transmission mode 1 or 2.

Referring to FIG. 8, a first PSCCH (or SA) period may start in a time resource unit apart by a predetermined offset from a specific system frame, where the predetermined offset is indicated by higher layer signaling. Each PSCCH period may include a PSCCH resource pool and a time resource unit pool for sidelink data transmission. The PSCCH resource pool may include the first time resource unit in the PSCCH period to the last time resource unit among time resource units indicated as carrying a PSCCH by a time resource unit bitmap. In mode 1, since a time-resource pattern for transmission (T-RPT) or a time-resource pattern (TRP) is applied, the resource pool for sidelink data transmission may include time resource units used for actual transmission. As shown in the drawing, when the number of time resource units included in the PSCCH period except for the PSCCH resource pool is more than the number of T-RPT bits, the T-RPT may be applied repeatedly, and the last applied T-RPT may be truncated as many as the number of remaining time resource units. A transmitting UE performs transmission at a T-RPT position of 1 in a T-RPT bitmap, and transmission is performed four times in one MAC PDU.

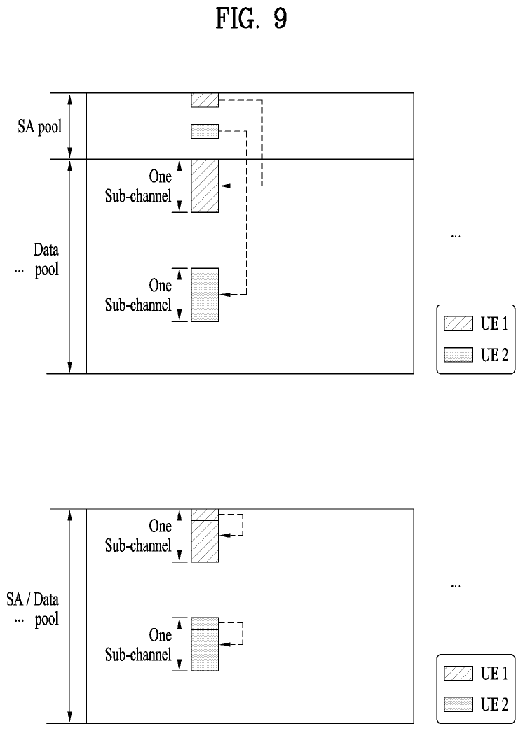

In V2X, that is, sidelink transmission mode 3 or 4, a PSCCH and data (PSSCH) are frequency division multiplexed (FDM) and transmitted, unlike sidelink communication. Since latency reduction is important in V2X in consideration of the nature of vehicle communication, the PSCCH and data are FDM and transmitted on the same time resources but different frequency resources. FIG. 9 illustrates examples of this transmission scheme. The PSCCH and data may not be contiguous to each other as illustrated in FIG. 9(a) or may be contiguous to each other as illustrated in FIG. 9(b). A subchannel is used as the basic unit for the transmission. The subchannel is a resource unit including one or more RBs in the frequency domain within a predetermined time resource (e.g., time resource unit). The number of RBs included in the subchannel, i.e., the size of the subchannel and the starting position of the subchannel in the frequency domain are indicated by higher layer signaling.

For V2V communication, a periodic type of cooperative awareness message (CAM) and an event-triggered type of decentralized environmental notification message (DENM) may be used. The CAM may include dynamic state information of a vehicle such as direction and speed, vehicle static data such as dimensions, and basic vehicle information such as ambient illumination states, path details, etc. The CAM may be 50 to 300 bytes long. In addition, the CAM is broadcast, and its latency should be less than 100 ms. The DENM may be generated upon occurrence of an unexpected incident such as a breakdown, an accident, etc. The DENM may be shorter than 3000 bytes, and it may be received by all vehicles within the transmission range. The DENM may have priority over the CAM. When it is said that messages are prioritized, it may mean that from the perspective of a UE, if there are a plurality of messages to be transmitted at the same time, a message with the highest priority is preferentially transmitted, or among the plurality of messages, the message with highest priority is transmitted earlier in time than other messages. From the perspective of multiple UEs, a high-priority message may be regarded to be less vulnerable to interference than a low-priority message, thereby reducing the probability of reception error. If security overhead is included in the CAM, the CAM may have a large message size compared to when there is no security overhead.

Sidelink Congestion Control

A sidelink radio communication environment may easily become congested according to increases in the density of vehicles, the amount of information transfer, etc. Various methods are applicable for congestion reduction. For example, distributed congestion control may be applied.

In the distributed congestion control, a UE understands the congestion level of a network and performs transmission control. In this case, the congestion control needs to be performed in consideration of the priorities of traffic (e.g., packets).

Specifically, each UE may measure a channel busy ratio (CBR) and then determine the maximum value (CRlimitk) of a channel occupancy ratio (CRk) that may be occupied by each traffic priority (e.g., k) according to the CBR. For example, the UE may calculate the maximum value (CRlimitk) of the channel occupancy ratio for each traffic priority based on CBR measurement values and a predetermined table. If traffic has a higher priority, the maximum value of the channel occupancy ratio may increase.

The UE may perform the congestion control as follows. The UE may limit the sum of the channel occupancy ratios of traffic with a priority k such that the sum does not exceed a predetermined value, where k is less than i. According to this method, the channel occupancy ratios of traffic with low priorities are further restricted.

Furthermore, the UE may use methods such as control of the magnitude of transmission power, packet drop, determination of retransmission or non-retransmission, and control of the size of a transmission RB (MCS adjustment).

5G Use Cases

Three main requirement categories for 5G include (1) a category of enhanced mobile broadband (eMBB), (2) a category of massive machine type communication (mMTC), and (3) a category of ultra-reliable and low-latency communications (URLLC).

Partial use cases may require a plurality of categories for optimization and other use cases may focus upon only one key performance indicator (KPI). 5G supports such various use cases using a flexible and reliable method.

eMBB far surpasses basic mobile Internet access and covers abundant bidirectional work and media and entertainment applications in cloud and augmented reality. Data is one of a core driving force of 5G and, in the 5G era, a dedicated voice service may not be provided for the first time. In 5G, it is expected that voice will simply be processed as an application program using data connection provided by a communication system. Main causes for increased traffic volume are increase in the size of content and an increase in the number of applications requiring high data transmission rate. A streaming service (of audio and video), conversational video, and mobile Internet access will be more widely used as more devices are connected to the Internet. These application programs require always-on connectivity in order to push real-time information and alerts to users. Cloud storage and applications are rapidly increasing in a mobile communication platform and may be applied to both work and entertainment. Cloud storage is a special use case which accelerates growth of uplink data transmission rate. 5G is also used for cloud-based remote work. When a tactile interface is used, 5G demands much lower end-to-end latency to maintain good user experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential IoT devices will reach 20.4 billion up to the year of 2020. Industrial IoT is one of categories of performing a main role enabling a smart city, asset tracking, smart utilities, agriculture, and security infrastructure through 5G.

URLLC includes new services that will transform industries with ultra-reliable/available, low-latency links such as remote control of critical infrastructure and a self-driving vehicle. A level of reliability and latency is essential to control and adjust a smart grid, industrial automation, robotics, and a drone.

Next, a plurality of use cases will be described in more detail.

5G is a means of providing streaming at a few hundred megabits per second to gigabits per second and may complement fiber-to-the-home (FTTH) and cable-based broadband (or DOCS). Such high speed is needed to deliver TV at a resolution of 4K or more (6K, 8K, and more), as well as virtual reality and augmented reality. Virtual reality (VR) and augmented reality (AR) applications include immersive sports games. A specific application program may require a special network configuration. For example, for VR games, gaming companies need to incorporate a core server into an edge network server of a network operator in order to minimize latency.

Automotive is expected to be a new important driving force in 5G together with many use cases for mobile communication for vehicles. For example, entertainment for passengers requires high simultaneous capacity and mobile broadband with high mobility. This is because future users continue to expect high connection quality regardless of location and speed. Another automotive use case is an AR dashboard. The AR dashboard displays information talking to a driver about a distance to an object and movement of the object by being superimposed on an object seen from a front window to identify an object in the dark. In the future, a wireless module will enable communication between vehicles, information exchange between a vehicle and supporting infrastructure, and information exchange between a vehicle and other connected devices (e.g., devices transported by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by a human being.

A smart city and a smart home mentioned as a smart society will be embedded in a high-density wireless sensor network. A distributed network of an intelligent sensor will identify conditions for costs and energy-efficient maintenance of a city or a home. Similar configurations may be performed for respective households. All temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is highly decentralized so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of energy such as electricity by a method having efficiency, reliability, economic feasibility, sustainability of production, and automatability. The smart grid may also be regarded as another sensor network having low latency.

A health care part contains many application programs capable of enjoying the benefits of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in an industrial application field. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of cables and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Positioning Measurement Method

The NG-RAN may support the following positioning methods: GNSS, observed time difference of arrival (OTDOA), enhanced cell ID (E-CID), barometric sensor positioning, WLAN positioning, Bluetooth positioning, terrestrial beacon system (TBS), uplink time difference of arrival (UTDOA), and so on. Although any one of the positioning methods may be used to estimate the position of the UE, two or more positioning methods may be used to estimate the position of the UE.

(1) OTDOA (Observed Time Difference of Arrival)

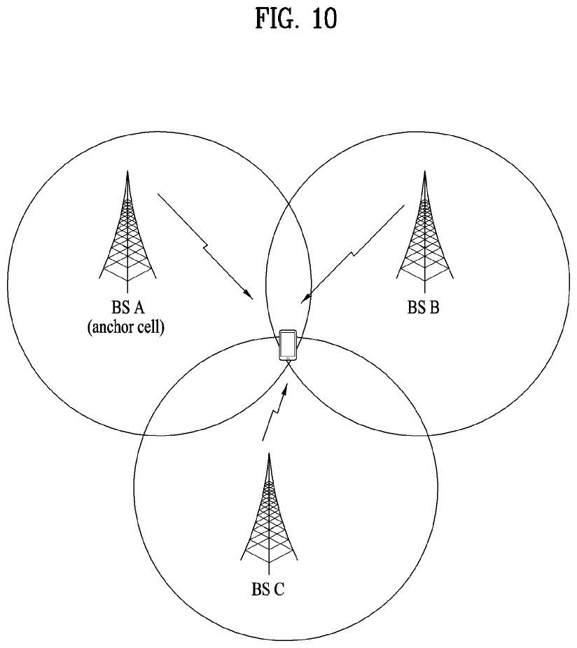

FIG. 10 is a diagram for explaining an OTDOA positioning method. The OTDOA positioning method uses measurement timings of DL signals received by the UE from multiple TPs including the eNB, ng-eNB, and PRS-only TP. The UE measures the timings of received DL signals based on location assistance data received from the location server. The location of the UE may be determined based on the measurement results and the geographical coordinates of neighboring TPs.

When the UE is connected to the gNB, the UE may request a measurement gap for OTDOA measurement from a TP. If the UE does not recognize the SFN for at least one TP in OTDOA assistance data, the UE may use an autonomous gap to obtain the SFN of an OTDOA reference cell before requesting a measurement gap for reference signal time difference (RSTD) measurement.

Herein, the RSTD may be defined based on the minimum relative time difference between the boundaries of two subframe received from reference and measurement cells. That is, the RSTD may be calculated based on the relative time difference between the start time of a subframe received from the measurement cell and the start time of a subframe from the reference cell, which is closest to the measurement cell. The reference cell may be selected by the UE.

For accurate OTDOA positioning, it is necessary to measure the times of arrival (ToAs) of signals received from geographically distributed three or more TPs or BSs. For example, ToAs for TP 1, TP 2, and TP 3 may be measured, and an RSTD for TP 1 and TP 2, an RSTD for TP 2 and TP 3, and an RSTD for TP 3 and TP 1 may be calculated based on the three ToAs. Then, a geometric hyperbola may be determined based on the calculated RSTD values, and a point at which the curves of the hyperbola intersect may be estimated as the position of the UE. In this case, each ToA measurement may have inaccuracy and uncertainty, and thus, the estimated position of the UE may be provided as a specific range according to measurement uncertainty.

For example, an RSTD for two TPs may be calculated based on Equation 1 below.

$$RSTDi , 1 = \frac{\sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} + {( {y}_{t} - {y}_{1} )}^{2}}}{c} + ( {T}_{i} - {T}_{1} ) + ( {n}_{i} - {n}_{1} ) \qquad [ Equation 1 ]$$

In Equation 3, c is the speed of light, {xₜ, yₜ} are (unknown) coordinates of a target UE, {xᵢ, yᵢ} are (known) coordinates of a TP, and {x₁, y₁} are coordinates of a reference TP (or another TP). Here, (Tᵢ−T₁) is a transmission time offset between two TPs, which may be referred to as real time differences (RTDs), and nᵢ and n₁ may be UE ToA measurement error values.

(2) E-CID (Enhanced Cell ID)

In a cell ID (CID) positioning method, the position of the UE may be measured based on geographical information about the serving ng-eNB, serving gNB, and/or serving cell of the UE. For example, the geographical information about the serving ng-eNB, serving gNB, and/or serving cell may be acquired from paging, registration, etc.

In an E-CID positioning method, additional UE measurements and/or NG-RAN radio resources may be further used to improve UE location estimation performance, compared to the CID positioning method. In the E-CID positioning method, some of the same measurement methods as the RRC protocol measurement control system may be used, but in general, no additional measurement may be performed only for UE positioning. In other words, to estimate the location of the UE, any separate measurement configurations or measurement control messages may not be provided. In addition, the UE may not expect that an additional measurement operation is requested for positioning, and the UE may report measurements obtained by general measurement methods.

For example, the serving gNB may perform the E-CID positioning method based on E-UTRA measurements provided by the UE.

The following measurement elements may be used for E-CID positioning.
UE measurement: E-UTRA reference signal received power (RSRP), E-UTRA reference signal received quality (RSRQ), UE E-UTRA reception-transmission time difference (RX-TX time difference), GERAN/WLAN reference signal strength indication (RSSI), UTRAN common pilot channel (CPICH) received signal code power (RSCP), and/or UTRAN CPICH Ec/Io
E-UTRAN measurement: ng-eNB RX-TX time difference, timing advance (T_{ADV}), and/or angle of arrival (AoA)

Here, T_{ADV} may be divided into Type 1 and Type 2 as follows.

T_{ADV} Type 1=(ng-eNB RX-TX time difference)+(UE E-UTRA RX-TX time difference)

T_{ADV} Type 2=ng-eNB RX-TX time difference

The AoA may be used to measure the direction of the UE. The AoA may be defined as an estimated angle for the location of the UE in the counterclockwise direction from the BS/TP. In this case, the geographical reference direction may be north. The BS/TP may use an UL signal such as a sounding reference signal (SRS) and/or a DMRS for AoA measurement. In addition, the larger the size of antenna arrays, the higher the measurement accuracy of the AoA. When the antenna arrays are placed at the same interval, signals received from adjacent antenna elements may have a constant phase rotate.

(3) UTDOA (Uplink Time Difference of Arrival)

UTDOA positioning is a method of determining the position of the UE by estimating the arrival time of an SRS. To estimate the arrival time of the SRS, the serving cell may be used as the reference cell, and then the position of the UE may be calculated based on the arrival time difference from another cell (or BS/TP). To obtain an UTDOA, the E-SMLC may indicate the serving cell of a target UE to instruct the target UE to perform SRS transmission. The E-SMLC may provide configurations such as a periodic/aperiodic SRS, a bandwidth and frequency/group/sequence hopping.

### Embodiments

The present disclosure proposes a method of removing a synchronization error between fixed nodes in UE positioning to estimate the location of a UE more effectively. The present disclosure proposes a method by which UEs share a time difference of arrival (TDOA) measurement or a reference signal time difference (RSTD) measurement between signals received from fixed nodes (e.g., anchor nodes) in order to remove a synchronization error between the fixed nodes (e.g., anchor nodes) and directly estimate the locations of the UEs that share the TDOA.

Cellular communication systems support various methods for detecting and tracking the locations of individual UEs based on a fixed node, a BS, or a UE. In general, a method of obtaining information about distances from a UE to BSs whose locations are already known and then estimating the location of the UE based on the information is widely used (for example, the distances between the UE and BSs may be directly used (e.g., round trip time (RTT)) or the distance differences between the UE and BSs may be used (e.g., TDOA)). To this end, a positioning reference signal (PRS) for a UE to reliably derive the reception time from a BS is defined in the LTE system. Specifically, the UE may use the PRS to measure and report an OTDOA (i.e., TDOA for the PRS). To allow the BS to perform a similar operation, the LTE system supports UTDOA measurement. To this end, an SRS may be used. The transmission frequency band of the SRS may be set to be wide. When each BS measures a TOA based on the SRS, the measured TOA may have high accuracy if the signal quality is good.

For the OTDOA, if there is a synchronization error between fixed nodes (e.g., a BS including an eNB or gNB or a relay node), the positioning error increases by the synchronization error.

The present disclosure proposes a method by which UEs share an RSTD (measurement result) value in order to remove a synchronization error between fixed nodes (e.g., anchor nodes) and achieve effective UE positioning.

A UE may receive predetermined reference signals (e.g., PRS) from fixed nodes (e.g., BS, RSU, relay, AN, etc.), and calculate a PRS reception time difference between the fixed nodes. The predetermined reference signals may be reference signals transmitted from fixed nodes or UEs for positioning. In this case, if there is a synchronization error between the fixed nodes, the UE positioning accuracy may be degraded. In particular, for high-precision positioning, very precise synchronization between fixed nodes is required. For example, even a synchronization error of 10 ns may cause a positioning error of about 3 meters. However, to achieve precise synchronization between fixed nodes by wire, high installation costs are required. In addition, there may be synchronization errors that cannot be technically eliminated, such as cabling loss. The present disclosure proposes a method for calculating a differential RSTD by sharing an RSTD (measurement) result between UEs and removing a synchronization error between fixed nodes based on the differential RSTD in order to estimate the location of the UE more precisely.

For convenience of description, several terms and variables are defined as follows.
Anchor node (AN): The AN refers to a node that has a fixed location or whose exact location is known. A UE moving around the AN may already know the location of the AN. Alternatively, when the UE transmits its measurement information to a specific node, it may be assumed that the specific node knows the location of the AN. The AN may be either a BS or a UE. The AN may act as a UE at the beginning of installation. Thereafter, after estimating its location from another AN, the AN may act as a BS connected to the network through a wireless backhaul.
UE: A mobile device, user equipment, hand held device, mobile equipment, vehicle device, etc. are hereinafter collectively referred to as a UE. The UE measures the location thereof by transmitting and receiving a signal from the AN. The UE may be a portable UE used by a pedestrian or a vehicle. Further, the UE may be a specific type of node (e.g., wireless AP, wireless relay, etc.) whose location is not determined but is intended to be fixed.
Location server: The location server refers to a physical or logical entity (e.g., E-SMLC, SUPL SLP, etc.) that manages UE positioning by obtaining measurement results (measurements) and other location information and providing auxiliary information (e.g., assistance data, etc.) to the UE. In addition, the location server may calculate, identify, and/or predict the last location of the UE. As an example, the location server may calculate a TDOA from a TOA.
PRS: The PRS may be a signal transmitted by the AN for positioning. Such a signal is called the PRS, for convenience of description. For example, the PRS may be transmitted on antenna port 6. The PRS may not be mapped to resource elements to which a PBCH, PSS, or SSS is allocated, regardless of antenna ports. The PRS is transmitted in predefined positioning subframes grouped by several consecutive subframes, NPRS, which are referred to as “positioning occasions”. The positioning occasion may occur periodically for every specific period TPRS.
RSTD: The UE receives assistance data from the BS and receives the PRS from a reference cell and neighboring cells based on the assistance data. Thereafter, the UE calculates RSTDs between the reference cell and neighboring cells and transmits the calculated RSTDs to the serving BS. Then, the serving BS transmits the RSTDs to the location server, and the location server determines the location of the UE based on the RSTDs. The RSTD refers to a relative time difference between the reference cell and neighboring cell and is defined by Equation 2 below.

RSTD=TsubframeRxj−TsubframeRxi [Equation 2]

In Equation 2, TSubframeRxj is the time when the UE receives the start of one subframe from neighboring cell j, and TSubframeRxi is the time when the UE receives the start of one subframe from reference cell i that is closest to the subframe received from cell j.

The reference cell and neighboring cells may transmit the PRS at similar times. If the reference cell and neighboring cells transmit the PRS at similar times, the difference between the time when the UE receives the PRS from the reference cell and the time when the UE receives the PRS from each of a plurality of neighboring cells may be within a certain time range. For example, the difference between the time when the UE receives the PRS from the reference cell and the time when the UE receives the PRS from each of the plurality of neighboring cells may be within one subframe. According to the RSTD definition, if one subframe that the UE receives from neighboring cell j is the first subframe of a PRS positioning occasion of neighboring cell j, one subframe received from cell i closest to the subframe received from cell j becomes the first subframe of a PRS positioning occasion of reference cell i. In this case, the PRS positioning occasion refers to consecutive DL subframes to which the PRS is allocated. Therefore, the RSTD becomes the difference between the time when the PRS is received from neighboring cell j and the time when the PRS is received from reference cell i. The time when the PRS is received from a specific cell is referred to as a PRS arrival time (hereinafter referred to as “ToA”).
Time Difference of Arrival (TDOA): The TDOA refers to a technique of measuring propagation delays of neighboring BSs based on a signal from the service BS, obtaining several hyperbolic curves by measuring differences in signal arrival time between the service BS and neighboring BSs, and estimating the intersection of these hyperbolas as the location of the UE. To calculate the accurate location of a receiver based on the intersection of three (or more) hyperboloids, TDOAs for at least three transmitters are required.
OTDOA: The OTDOA is a DL positioning method of LTE. This method includes a process in which the UE measures arrival times (e.g., TOA) of signals received from a plurality of BSs. In addition, a process of subtracting each of the TOAs of the signals received from the plurality of BSs from the TOA of a signal received from the reference BS (e.g., service BS) is included. Geometrically, each time (or range) difference determines a hyperbola, and the point at which hyperbolas intersect corresponds to the location of the UE. To obtain the two coordinates (x and y or latitude/longitude) of the UE, at least three timing measurements needs to be measured from geographically dispersed BSs with good geometry. The intersection area of two hyperbolas corresponds to the estimated UE position.
Signal transmitted by m-th AN: To estimate the location of the UE, the fixed node (AN) may transmit the PRS. A signal, for example, PRS, transmitted by the m-th AN at time t may be represented by xₘ(t).
A radio channel between the m-th AN and an i-th UE may be represented by hₘᵢ(t)
The reception signal of the UE receiving the signal transmitted by the m-th AN may be represented by yₘᵢ(t). yₘᵢ(t) is defined by yₘᵢ(t)=hₘᵢ(t)*xₘ(t−τₘ)+n(t), where n(t) denotes noise, and τₘⁱ denotes a propagation reception delay time depending on the distance when the i-th UE receives the PRS transmitted from the m-th AN. Also, * may represent convolution or multiplication. In this case, the delay time may include various propagation delays, processing delays, and synchronization errors between the UE and the fixed node (e.g., AN).
The difference between the time when the i-th UE receives a signal transmitted from the m-th AN at time t and the time when the i-th UE receives a signal transmitted from the n-th AN at time t may be represented by \hat{τ}ₘⁱ(t)−\hat{τ}ₙⁱ(t)+Δ_{m,n}(t) where \hat{τ}ₘⁱ(t) denotes the estimated delay time of the signal received by the i-th UE from the m-th AN at time t (e.g., the first timing), and Δ_{m,n} denotes a synchronization error between the m-th AN and the n-th AN. This measurement may be referred to as the RSTD or TDOA. Since the measurement result of the i-th UE may include the synchronization error between the two different ANs, a position estimation error may occur in UE positioning. If the clock drift of the AN is very small, the following may be assumed: Δ_{m,n}(t)=Δ_{m,n}, ∀t where ∀ may mean all (for all, for every).
Sidelink transmission mode 1 (sidelink mode 1): Sidelink mode 1 may be a mode in which resource allocation is indicated by the BS. Sidelink transmission mode 1 may be viewed as a centralized mode. In this mode, radio resources used by the UE for direct communication (e.g., D2D communication) may be scheduled by the BS.
Sidelink transmission mode 2 (sidelink mode 2): Sidelink mode 2 may be a mode in which the UE autonomously determines radio resources for sidelink communication. Sidelink transmission mode 2 may be regarded as a distributed mode.

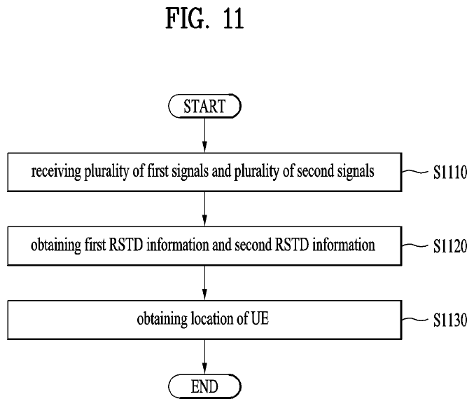

FIG. 11 is a flowchart illustrating an embodiment of the present disclosure.

Referring to FIG. 11, a method of measuring the location of a UE in a wireless communication system is provided in an embodiment of the present disclosure. The method may include: receiving, by the UE, a plurality of first signals from a first fixed node and a second fixed node; (S1110); receiving, by the UE, a plurality of second signals from the first fixed node and the second fixed node (S1110); obtaining, by the UE, first RSTD information based on the plurality of received first signals (S1120); obtaining, by the UE, second RSTD information based on the plurality of received second signals (S1120); and measuring, by the UE, the location of the UE based on the first RSTD information and the second RSTD information (S1130). The plurality of first signals may be transmitted from the first fixed node and the second fixed node at a first transmission timing, and the plurality of second signals may be transmitted from the first fixed node and the second fixed node at a second transmission timing different from the first transmission timing. The measurement of the location of the UE (S1130) of FIG. 11 may further include measuring the location of the UE by removing a synchronization error between the first fixed node and the second fixed node based on a difference between the first RSTD information and the second RSTD information. The measurement of the location of the UE may further include measuring the location of the UE by removing a synchronization error between the second fixed node and a third fixed node based on a difference between third RSTD information and fourth RSTD information.

The method of FIG. 11 may further include: receiving, by the UE, the plurality of first signals from the third fixed node; receiving, by the UE, the plurality of second signals from the third fixed node; obtaining, by the UE, the third RSTD information based on the first signals received from the second fixed node and the third fixed node; obtaining, by the UE, the fourth RSTD information based on the second signals received from the second fixed node and the third fixed node; and measuring, by the UE, the location of the UE based on the first RSTD information, the second RSTD information, the third RSTD information, and the fourth RSTD information. The plurality of first signals may be transmitted from the first fixed node, the second fixed node, and the third fixed node at the first transmission timing, and the plurality of second signals may be transmitted from the first fixed node, the second fixed node, and the third fixed node at the second transmission timing different from the first transmission timing.

The method of FIG. 11 may further include: measuring, by the UE, a distance between a first location of the UE at the first transmission timing and a second location of the UE at the second transmission timing based on sensor information of the UE; and measuring, by the UE, the first location of the UE at the first transmission timing.

The method of FIG. 11 may include: receiving, by the UE, location information on the first fixed node, location information on the second fixed node, and location information on the third fixed node from the first fixed node, the second fixed node, or the third fixed node; and measuring, by the UE, the location of the UE based on the first RSTD information, the second RSTD information, the third RSTD information, the fourth RSTD information, the location information on the first fixed node, the location information on the second fixed node, and the location information on the third fixed node. To this end, the location information on the first fixed node and the location information on the second fixed node may be shared between the first fixed node and the second fixed node.

The method may include: transmitting, by the UE, the first RSTD information, the second RSTD information, the third RSTD information, and the fourth RSTD information to the first fixed node, the second fixed node, or the third fixed node; transmitting, by the UE, information on the distance between the first location of the UE at the first transmission timing and the second location of the UE at the second transmission timing to the first fixed node, the second fixed node, or the third fixed node based on the sensor information of the UE; and receiving, by the UE, information on the location of the UE from the first fixed node, the second fixed node, or the third fixed node. The received information may be obtained by the first fixed node, the second fixed node, or the third fixed node from information on the difference between the first RSTD information and the second RSTD information, information on a difference between the third RSTD information and the fourth RSTD information, and the information on the distance between the first location of the UE at the first transmission timing and the second location of the UE at the second transmission timing.

The method of FIG. 11 may further include: transmitting, by the UE, the information on the difference between the first RSTD information and the second RSTD information and the information on the difference between the third RSTD information and the fourth RSTD information to the first fixed node, the second fixed node, or the third fixed node; transmitting, by the UE, the information on the distance between the first location of the UE at the first transmission timing and the second location of the UE at the second transmission timing to the first fixed node, the second fixed node, or the third fixed node based on the sensor information of the UE; and receiving, by the UE, the information on the location of the UE from the first fixed node, the second fixed node, or the third fixed node. The received information may be obtained by the first fixed node, the second fixed node, or the third fixed node from the information on the difference between the first RSTD information and the second RSTD information, the information on the difference between the third RSTD information and the fourth RSTD information, and the information on the distance between the first location of the UE at the first transmission timing and the second location of the UE at the second transmission timing.

According to an embodiment of the present disclosure, at least one of the following operations may be included.

The UE may measure an RSTD value (e.g., first RSTD information) at a specific time, i.e., time t (e.g., first timing). Thereafter, the UE measures an RSTD value (e.g., second RSTD information) at time t′ (e.g., second timing) and then calculate a difference between the RSTDs. That is, the UE obtains/calculates/computes the difference between the RSTDs. For example, the UE may obtain information on a difference between the first RSTD information and the second RSTD information.

For example, a case where the first fixed node is AN m and the second fixed node is AN n will be described. For AN m and AN n, UE i may calculate a difference between RSTD information (e.g., RSTD measurement results) for two different times as shown in Equation 3.

\hat{τ}ₘⁱ(t)−\hat{τ}ₙⁱ(t)+Δ_{m,n}−(\hat{τ}ₘⁱ(t′)−\hat{τ}ₙⁱ(t′))−Δ_{m,n}=\hat{τ}ₘⁱ(t)−\hat{τ}ₙⁱ(t)−(\hat{τ}ₘⁱ(t′)−\hat{τ}ₙⁱ(t′)) [Equation 3]

The UE remove a synchronization error between a plurality of ANs based on an RSTD difference at different times (e.g., first and second transmission timings) according to Equation 3.

When the difference between RSTDs (measurement results) at different times, that is, the RSTD difference is calculated/obtained/computed, the following conditions may need to be satisfied to determine the location of the corresponding UE.

The number of independent RSTD differences needs to be greater than the number of unknowns to be calculated. For example, if two-dimensional (2D) location information about the UE (e.g., 2D coordinates (x(t), y(t)) and (x(t′), y(t′))) is required, the total number of unknowns is 4. However, x(t′) and y(t′) may be represented as x(t′)=x(t)+p, y(t′)=y(t)+q based on the sensor information of the UE, and in this case, the number of unknowns is reduced to 2. In the above equation, p and q may mean relative distance differences depending on times measured based on the sensor information. The method of FIG. 11 may further include: measuring, by the UE, the distance between the first location of the UE at the first transmission timing and the second location of the UE at the second transmission timing based on the sensor information of the UE; and measuring, by the UE, the first location of the UE at the first transmission timing.

In this case, if the UE calculates RSTD values from two fixed nodes (e.g., AN) and computes the difference therebetween, the UE may require one equation, for example, Equation 3. Since there are two unknowns, two or more equations are needed to find the unknowns. When the number of fixed nodes is 3, the number of independent RSTD differences is 2. When the number of fixed nodes is 4, the number of independent RSTD differences is 4−1=3. It may be generalized as follows: when the number of fixed nodes is N, the number of independent RSTD differences becomes N−1. That is, if the UE measures RSTDs from three or more fixed nodes and calculates the difference between the measured results based on time differences, the UE may obtain the location of the UE with no synchronization error between the fixed nodes. The UE may obtain the accurate location of the UE based on location information on the fixed nodes and the RSTD difference. The method of FIG. 11 may include: receiving, by the UE, the plurality of first signals from the third fixed node; receiving, by the UE, the plurality of second signals from the third fixed node; obtaining, by the UE, the third RSTD information based on the first signals received from the second fixed node and the third fixed node; obtaining, by the UE, the fourth RSTD information based on the second signals received from the second fixed node and the third fixed node; and measuring, by the UE, the location of the UE based on the first RSTD information, the second RSTD information, the third RSTD information, and the fourth RSTD information. The plurality of first signals may be transmitted from the first fixed node, the second fixed node, and the third fixed node at the first transmission timing, and the plurality of second signals may be transmitted from the first fixed node, the second fixed node, and the third fixed node at the second transmission timing different from the first transmission timing.

According to an embodiment of the present disclosure, the following technical effects may be expected.

There are no effects from a synchronization error between fixed nodes. Accordingly, no effort and operation are required for synchronization with the fixed nodes, thereby reducing the cost and complexity of installing the fixed nodes.

The relative location change may be measured based on the sensor information of the UE, thereby measuring the location more precisely.

In summary, the UE may perform the following operations to precisely measure the location of the UE with no effects from the synchronization error between the fixed nodes.

Step 1) the fixed nodes transmit a first signal (e.g., PRS) at time t (e.g., first transmission timing).

Step 2) the UE measures a (first) RSTD value at time t (e.g., first transmission timing).

Step 3) the fixed nodes transmit a second signal (e.g., PRS) at time t′ (e.g., second transmission timing).

Step 4) the UE measures a (second) RSTD value at time t′ (e.g., second transmission timing) and calculates the difference between the (first) RSTD value measured in step 1 and the (second) RSTD value. The UE calculates the location of the UE based on the relative location change of the UE measured by sensors (or measured based on the sensor information).

In step 4, the UE may not autonomously measure the location of the UE by measuring the RSTD values but report the RSTD values to a fixed node (e.g., AN) or server (e.g., location server) so that the fixed node or server may determine the location of the UE. To this end, the UE needs to report/transmit to the fixed node (e.g., AN) or server (e.g., location server) information on the relative location change over time based on its sensor measurement results. The UE may report the RSTD (measurement result) values and its location change to the fixed node (e.g., AN) or server (e.g., location server) with a physical layer or higher layer signal. The method of FIG. 11 may further include: transmitting, by the UE, the information on the difference between the first RSTD information and the second RSTD information to the first fixed node or the second fixed node; and receiving, by the UE, the information on the location of the UE from the first fixed node or the second fixed node. The received information (i.e., information on the location of the UE) may be obtained by the first fixed node or the second fixed node from the information on the difference between the first RSTD information and the second RSTD information.

If the UE intends to obtain/estimate three-dimensional (3D) location information (e.g., x, y, z coordinates), it may be converted into a problem that the UE needs to simultaneously figure out its three unknowns and three unknowns of another UE. To solve an equation with 6 unknowns, the UE needs to measure 6 or more independent RSTD differences. To this end, the UE needs to successfully receive signals from 7 or more ANs. This may cause a problem that the UE should receive signals from many ANs in the vicinity thereof. To solve such a problem, the UE may directly signal information on its altitude (height or z-axis) to another UE. For example, the UE may measure its altitude by using the barometer (e.g., pressure sensor) of the UE and transmit the altitude (height or z-axis) information together when sharing the RSTD information. Thus, it may be unnecessary to estimate the altitude of the UE. According to an embodiment of the present disclosure, the above processes may provide the technical effect that the number of fixed nodes (e.g., ANs) to be measured by the UE may be reduced.

Example of Communication System to which the Present Disclosure is Applied

Various descriptions, functions, procedures, proposals, methods and/or operational flowcharts of the present disclosure disclosed in this document are applicable, but limited, to various fields requiring wireless communication/connection (e.g., 5G) between devices.

Hereinafter, examples will be illustrated in more detail with reference to the drawings. In the following drawings/description, the same reference numerals may exemplify the same or corresponding hardware blocks, software blocks, or functional blocks, unless otherwise indicated.

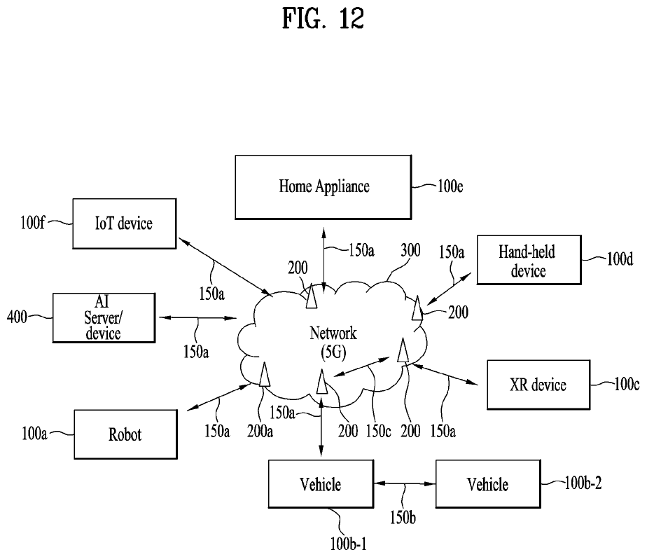

FIG. 12 illustrates a communication system 1 applied to the present disclosure.

Referring to FIG. 12, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices Applicable to the Present Disclosure

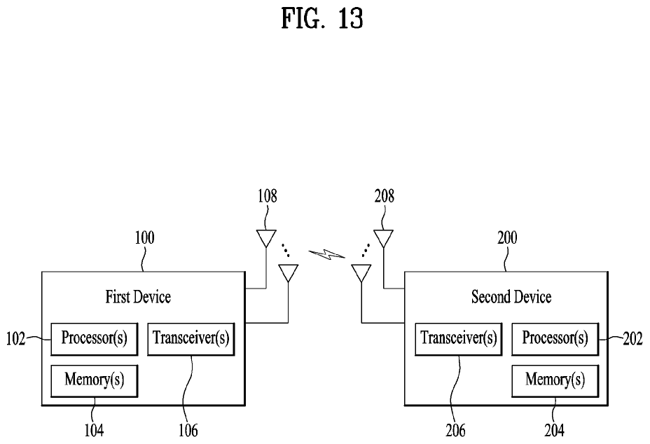

FIG. 13 illustrates wireless devices applicable to the present disclosure.

Referring to FIG. 13, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 12.

The first wireless device 100 may include one or more processors 102 and one or more memories 104. Additionally, the first wireless device 100 may further include one or more transceivers 106 and/or one or more antennas 108. The processor(s) 102 may be configured to control the memory(s) 104 and/or the transceiver(s) 106 and implement the descriptions, functions, procedures, proposals, methods, and/or operational flowcharts disclosed in this document. For example, the processor(s) 102 may be configured to perform at least one of the operations in the methods described above with reference to FIG. 11. For example, the processor(s) 102 may be configured to control the transceiver(s) 106 to receive a plurality of first signals from a first fixed node and a second fixed node and receive a plurality of second signals from the first fixed node and the second fixed node; obtain first RSTD information based on the plurality of received first signals; obtain second RSTD information based on the plurality of received second signals; and measure the location of a UE based on the first RSTD information and the second RSTD information.

The processor(s) 102 may be configured to process information in the memory(s) 104, generate first information/signals, and transmit radio signals including the first information/signals through the transceiver(s) 106. The processor(s) 102 may be configured to receive radio signals including second information/signals through the transceiver(s) 106 and store information obtained by processing the second information/signals in the memory(s) 104. The memory(s) 104 may be connected to the processor(s) 102 and configured to store various information related to operations of the processor(s) 102. For example, the memory(s) 104 may be configured to store software code including commands for performing all or some of the processes controlled by the processor(s) 102 or commands for performing the descriptions, functions, procedures, proposals, methods, and/or operational flowcharts disclosed in this document. Herein, the processor(s) 102 and the memory(s) 104 may be a part of a communication modem/circuit/chip designed to implement wireless communication technologies (e.g., LTE or NR). The transceiver(s) 106 may be connected to the processor(s) 102 and configured transmit and/or receive radio signals through the one or more antennas 108. Each of the transceiver(s) 106 may include a transmitter and/or a receiver. The transceiver(s) 106 may be interchangeably used with the term “RF unit”. In the present disclosure, the wireless device may mean a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Signal Processing Circuit to which the Present Disclosure is Applicable

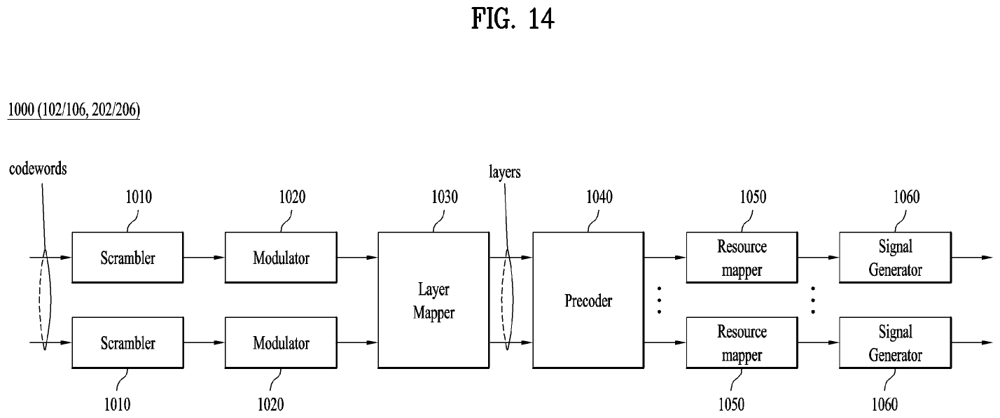

FIG. 14 illustrates a signal process circuit for a transmission signal.

Referring to FIG. 14, a signal processing circuit 1000 may include scramblers 1010, modulators 1020, a layer mapper 1030, a precoder 1040, resource mappers 1050, and signal generators 1060. An operation/function of FIG. 14 may be performed, without being limited to, the processors 102 and 202 and/or the transceivers 106 and 206 of FIG. 13. Hardware elements of FIG. 14 may be implemented by the processors 102 and 202 and/or the transceivers 106 and 206 of FIG. 13. For example, blocks 1010 to 1060 may be implemented by the processors 102 and 202 of FIG. 13. Alternatively, the blocks 1010 to 1050 may be implemented by the processors 102 and 202 of FIG. 13 and the block 1060 may be implemented by the transceivers 106 and 206 of FIG. 13.

Codewords may be converted into radio signals via the signal processing circuit 1000 of FIG. 14. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include IFFT modules, CP inserters, digital-to-analog converters (DACs), and frequency up-converters.

Signal processing procedures for a signal received in the wireless device may be configured in a reverse manner of the signal processing procedures 1010 to 1060 of FIG. 14. For example, the wireless devices (e.g., 100 and 200 of FIG. 13) may receive radio signals from the exterior through the antenna ports/transceivers. The received radio signals may be converted into baseband signals through signal restorers. To this end, the signal restorers may include frequency DL converters, analog-to-digital converters (ADCs), CP remover, and FFT modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Use Cases of Wireless Devices to which the Present Disclosure is Applied

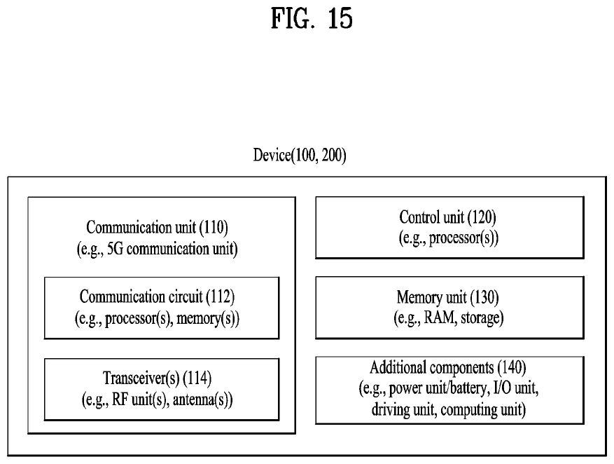

FIG. 15 is a block diagram illustrating a wireless device to which another embodiment of the present disclosure may be applied. The wireless device may be implemented in various forms according to a use case/service (refer to FIG. 12 and FIGS. 16 to 18).

Referring to FIG. 15, wireless devices 100 and 200 may correspond to the wireless devices 100 and 200 of FIG. 13 and include various elements, components, units, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 13. For example, the transceiver(s) 114 may include the one or more transceivers 106 and 206 and/or the one or more antennas 108 and 208 of FIG. 13. The control unit 120 may be electrically connected to the communication unit 110, the memory 130, and the additional components 140 and configured to control the overall operations of the wireless device. For example, the control unit 120 may be configured to control electric/mechanical operations of the wireless device based on programs/code/commands/information stored in the memory unit 130. The control unit 120 may be configured to transmit the information stored in the memory unit 130 to the outside (e.g., other communication devices) through the communication unit 110 over a wireless/wired interface. Further, the control unit 120 may be configured to store information received from the outside (e.g., other communication devices) through the communication unit 110 over the wireless/wired interface in the memory unit 130. For example, the control unit 120 may be configured to perform at least one of the operations in the methods described above with reference to FIG. 11. For example, the control unit 120 may be configured to control the communication unit 110 to receive a plurality of first signals from a first fixed node and a second fixed node and receive a plurality of second signals from the first fixed node and the second fixed node; obtain first RSTD information based on the plurality of received first signals; obtain second RSTD information based on the plurality of received second signals; and measure the location of a UE based on the first RSTD information and the second RSTD information.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 12), the vehicles (100b-1 and 100b-2 of FIG. 12), the XR device (100c of FIG. 12), the hand-held device (100d of FIG. 12), the home appliance (100e of FIG. 12), the IoT device (100f of FIG. 12), a digital broadcast terminal, a hologram device, a public safety device, an MTC device, a medicine device, a FinTech device (or a finance device), a security device, a climate/environment device, the AI server/device (400 of FIG. 12), the BSs (200 of FIG. 12), a network node, etc. The wireless device may be used in a mobile or fixed place according to a use-example/service.

In FIG. 15, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

Hereinafter, an example of implementing FIG. 15 will be described in detail with reference to the drawings.

Examples of a Hand-Held Device Applicable to the Present Disclosure

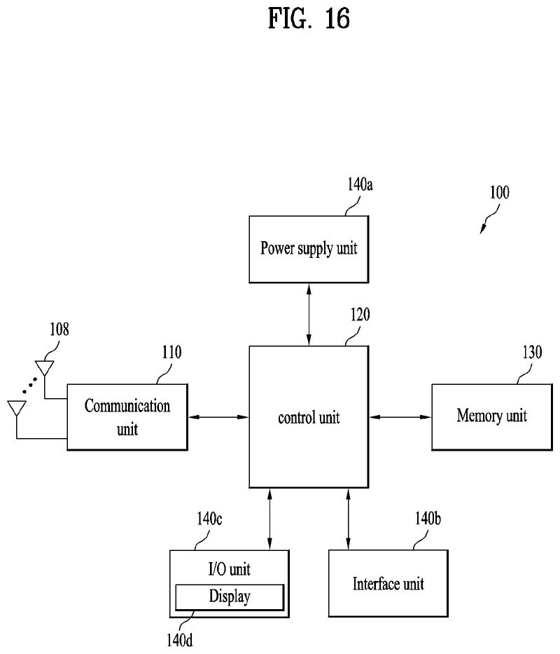

FIG. 16 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a mobile subscriber station (MSS), a subscriber station (SS), an advanced mobile station (AMS), or a wireless terminal (WT).

Referring to FIG. 16, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 15, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an application processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Examples of a Vehicle or an Autonomous Driving Vehicle Applicable to the Present Disclosure

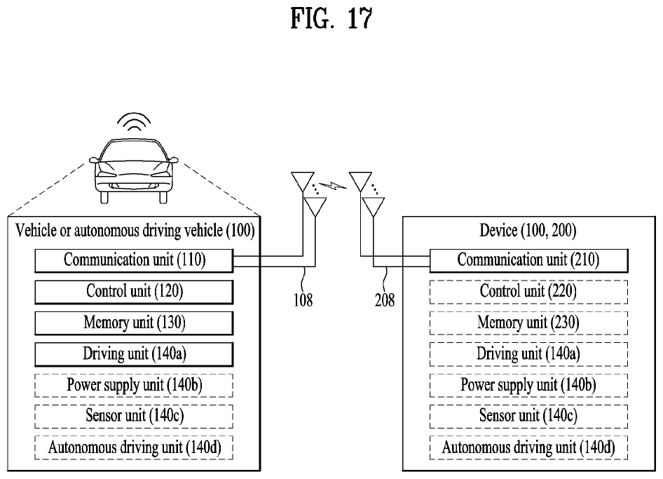

FIG. 17 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 17, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 15, respectively.

The communication unit 110 may be configured to transmit and receive signals (e.g., data and control signals) to and from an external device such as another vehicles, a BS (e.g., gNB, roadside BS (road side unit), etc.), and a server. The control unit 120 may be configured to perform various operations by controlling elements of the vehicle or the autonomous driving vehicle 100. The control unit 120 may include an electronic control unit (ECU). The control unit 120 may be configured to perform at least one of the operations in the methods described above with reference to FIG. 11. For example, the control unit 120 may be configured to control the communication unit 110 to receive a plurality of first signals from a first fixed node and a second fixed node and receive a plurality of second signals from the first fixed node and the second fixed node; obtain first RSTD information based on the plurality of received first signals; obtain second RSTD information based on the plurality of received second signals; and measure the location of a UE based on the first RSTD information and the second RSTD information.

The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Examples of a Vehicle and AR/VR Applicable to the Present Disclosure

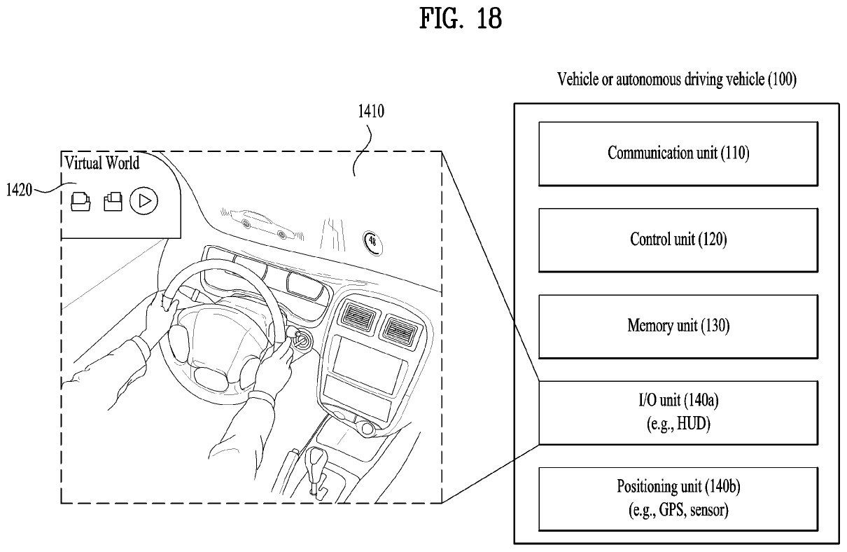

FIG. 18 illustrates a vehicle applied to the present disclosure. The vehicle may be implemented as a transport means, an aerial vehicle, a ship, etc.

Referring to FIG. 18, a vehicle 100 may include a communication unit 110, a control unit 120, a memory unit 130, an I/O unit 140a, and a positioning unit 140b. Herein, the blocks 110 to 130/140a and 140b correspond to blocks 110 to 130/140 of FIG. 15.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

The above-described embodiments correspond to combinations of elements and features of the present disclosure in prescribed forms. And, the respective elements or features may be considered as selective unless they are explicitly mentioned. Each of the elements or features may be implemented in a form failing to be combined with other elements or features. Moreover, it is able to implement an embodiment of the present disclosure by combining elements and/or features together in part. A sequence of operations explained for each embodiment of the present disclosure may be modified. Some configurations or features of one embodiment may be included in another embodiment or may be substituted for corresponding configurations or features of another embodiment. And, it is apparently understandable that an embodiment is configured by combining claims failing to have relation of explicit citation in the appended claims together or may be included as new claims by amendment after filing an application.

In this document, embodiments of the present disclosure have been described mainly based on a signal transmission/reception relationship between a terminal and a base station. Such a transmission/reception relationship is applied to signal transmission/reception between a terminal and a relay or between a base station and a relay in in the same/similar manner. In some cases, a specific operation described in this document as being performed by the base station may be performed by an upper node thereof. That is, it is apparent that various operations performed for communication with a terminal in a network including a plurality of network nodes including a base station may be performed by the base station or network nodes other than the base station. The base station may be replaced with terms such as fixed station, Node B, eNode B (eNB), gNode B (gNB), access point, or the like. In addition, the terminal may be replaced with terms such as User Equipment (UE), Mobile Station (MS), Mobile Subscriber Station (MSS), or the like.

The examples of the present disclosure may be implemented through various means. For example, the examples may be implemented by hardware, firmware, software, or a combination thereof. When implemented by hardware, an example of the present disclosure may be implemented by one or more application specific integrated circuits (ASICs), one or more digital signal processors (DSPs), one or more digital signal processing devices (DSPDs), one or more programmable logic devices (PLDs), one or more field programmable gate arrays (FPGAs), one or more processors, one or more controllers, one or more microcontrollers, one or more microprocessor, or the like.

When implemented by firmware or software, an example of the present disclosure may be implemented in the form of a module, a procedure, or a function that performs the functions or operations described above. Software code may be stored in a memory unit and executed by a processor. The memory unit may be located inside or outside the processor, and may exchange data with the processor by various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-mentioned embodiments of the present disclosure are applicable to various mobile communication systems.

1. A method of measuring a location of a user equipment (UE) in a wireless communication system, the method comprising:
receiving, by the UE, a plurality of first signals from a first fixed node and a second fixed node;
receiving, by the UE, a plurality of second signals from the first fixed node and the second fixed node;
obtaining, by the UE, first reference signal time difference (RSTD) information based on the plurality of received first signals;
obtaining, by the UE, second RSTD information based on the plurality of received second signals; and
measuring, by the UE, the location of the UE based on the first RSTD information and the second RSTD information.

2. The method of claim 1, wherein the plurality of first signals are transmitted from the first fixed node and the second fixed node at a first transmission timing, and
wherein the plurality of second signals are transmitted from the first fixed node and the second fixed node at a second transmission timing different from the first transmission timing.

3. The method of claim 2, further comprising:
receiving, by the UE, the plurality of first signals from a third fixed node;
receiving, by the UE, the plurality of second signals from the third fixed node;
obtaining, by the UE, third RSTD information based on the first signals received from the second fixed node and the third fixed node;
obtaining, by the UE, fourth RSTD information based on the second signals received from the second fixed node and the third fixed node; and
measuring, by the UE, the location of the UE based on the first RSTD information, the second RSTD information, the third RSTD information, and the fourth RSTD information,
wherein the plurality of first signals are transmitted from the first fixed node, the second fixed node, and the third fixed node at the first transmission timing, and
wherein the plurality of second signals are transmitted from the first fixed node, the second fixed node, and the third fixed node at the second transmission timing different from the first transmission timing.

4. The method of claim 2, further comprising:
measuring, by the UE, a distance between a first location of the UE at the first transmission timing and a second location of the UE at the second transmission timing based on sensor information of the UE; and
measuring, by the UE, the first location of the UE at the first transmission timing.

5. The method of claim 1, wherein measuring the location of the UE further comprises measuring the location of the UE by removing a synchronization error between the first fixed node and the second fixed node based on a difference between the first RSTD information and the second RSTD information.

6. The method of claim 3, wherein measuring the location of the UE further comprises measuring the location of the UE by removing a synchronization error between the second fixed node and the third fixed node based on a difference between the third RSTD information and the fourth RSTD information.

7. The method of claim 3, comprising:
receiving, by the UE, location information on the first fixed node, location information on the second fixed node, and location information on the third fixed node from the first fixed node, the second fixed node, or the third fixed node; and
measuring, by the UE, the location of the UE based on the first RSTD information, the second RSTD information, the third RSTD information, the fourth RSTD information, the location information on the first fixed node, the location information on the second fixed node, and the location information on the third fixed node.

8. The method of claim 3, further comprising:
transmitting, by the UE, the first RSTD information, the second RSTD information, the third RSTD information, and the fourth RSTD information to the first fixed node, the second fixed node, or the third fixed node;
transmitting, by the UE, information on a distance between a first location of the UE at the first transmission timing and a second location of the UE at the second transmission timing to the first fixed node, the second transmitting the fixed node, or the third fixed node based on sensor information of the UE; and
receiving, by the UE, information on the location of the UE from the first fixed node, the second fixed node, or the third fixed node,
wherein the received information is obtained by the first fixed node, the second fixed node, or the third fixed node from information on a difference between the first RSTD information and the second RSTD information, information on a difference between the third RSTD information and the fourth RSTD information, and the information on the distance between the first location of the UE at the first transmission timing and the second location of the UE at the second transmission timing.

9. A user equipment (UE) in a wireless communication system, the UE comprising:
a transceiver; and
a processor,
wherein the processor is configured to:
receive a plurality of first signals from a first fixed node and a second fixed node;
receive a plurality of second signals from the first fixed node and the second fixed node;
obtain first reference signal time difference (RSTD) information based on the plurality of received first signals;
obtain second RSTD information based on the plurality of received second signals; and
measure a location of the UE based on the first RSTD information and the second RSTD information.

10. The UE of claim 9, wherein the UE is configured to communicate with at least one of a mobile terminal, a network, or an autonomous driving vehicle other than an apparatus.

11. The UE of claim 9, wherein the UE is configured to implement at least one advanced driver assistance system (ADAS) function based on a signal for controlling movement of the UE.

12. The UE of claim 9, wherein the UE is configured to switch a driving mode of an apparatus from an autonomous driving mode to a manual driving mode or from the manual driving mode to the autonomous driving mode upon receipt of a user input.

13. The UE of claim 9, wherein the UE is configured to perform autonomous driving based on external object information, and
wherein the external object information includes at least one of information on presence of an object, information on a location of the object, information on a distance between the UE and the object, or information on a relative speed of the UE with respect to the object.
